(19) United States
(12) Patent Application Publication
(10) Pub. No.: US 2011/0179047 A1
(43) Pub. Date: Jul. 21, 2011

(54) METHOD AND SYSTEM FOR FUZZY SEARCHING, SEARCHING RESULT PROCESSING, AND FILTER CONDITION PROCESSING

(75) Inventors: Bin Zhang, Beijing (CN); Fengxin Jin, Beijing (CN); Guohui Li, Beijing (CN)

(73) Assignee: Huawei Technologies Co., Ltd., Shenzhen (CN)

(21) Appl. No.: 13/073,667

(22) Filed: Mar. 28, 2011

Related U.S. Application Data
(63) Continuation of application No. PCT/CN2009/074132, filed on Sep. 23, 2009.

(30) Foreign Application Priority Data
Sep. 28, 2008 (CN) 200810166965.2

(51) Int. Cl. G06F 17/30

(52) U.S. Cl. 707/754; 707/780; 707/E17.014; 707/E17.059

(57) ABSTRACT

A method and system for fuzzy searching, searching result processing and filter condition processing are provided. The method for fuzzy searching based on subtree filtering includes: receiving a data flow to be filtered; and filtering the data flow in an incomplete matching manner, and processing a filter condition in a form of character string for which a user does not give complete information. Therefore, inconvenience that a NETCONF protocol subtree filtering mechanism is only limited to exact matching and absolute path, and more known information is required in data searching is resolved.

### CROSS-REFERENCE TO RELATED APPLICATIONS

This application is a continuation of International Application No. PCT/CN2009/074132, filed on Sep. 23, 2009, which claims priority to Chinese Patent Application No. 200810166965.2, filed on Sep. 28, 2008, both of which are hereby incorporated by reference in their entireties.

### TECHNICAL FIELD

The present invention relates to the field of communication technologies, and in particular, to a method and system for fuzzy searching, a searching result processing and filter condition processing.

### BACKGROUND

As a network management protocol, the Network Configuration (NETCONF) Protocol describes operation requests and network management data by using an Extensible Markup Language (XML). Being a set of semantic mark rules, the XML divides documents into many components and identifies the components by using marks. The marks usually adopt a natural language, so as to have quite high readability. The marks are as follows:

```
<age>10</age>
<name language=“English”>
  <first-name>George</first-name>
  <last-name>Bush</last-name>
</name>
<hobby></hobby>
<hobby/>
```

Each pair of marks are formed by a start mark (for example, <age>) and an end mark (for example, </age>), and each pair of marks and the content of each pair of marks are called an element, where in the above example, <age> and <name> are the elements. An element may have a value, for example, the value of <age> is 10; an element may also have sub-elements, for example, <name> has sub-elements being <first-name> and <last-name>; an element may not have a value, for example, <hobby>, in this situation, the element is called an empty element, and is abbreviated as <hobby/>; and an element may also have an attribute, where the attribute is a “name-value” pair, for example, <name> has an attribute “language”, and an attribute value is “English”.

FIG. 1 is a schematic view of a tree data structure in the prior art. A hierarchy nesting relation between elements is usually expressed as a tree data structure as shown in FIG. 1, so that the elements are called nodes. In a pair of nesting relations, an external layer node is called a parent node of an internal layer node; and the internal layer node is called a child node of the external layer node. As shown in FIG. 1, <a> is the parent node of <b1>, <b2>, and <b3>; and <b1>, <b2>, and <b3> are the child nodes of <a>. The nodes having the same parent node are called sibling nodes, for example, <b1>, <b2>, and <b3> are sibling nodes.

In the network management, the configuration and the status of the network device are required to be monitored. In order to achieve the objective, the network management device sends a searching packet to describe the data to be searched for, and after receiving the searching packet, the managed device executes searching according to the condition in the searching packet, and replies a searching result to the network management device.

The NETCONF protocol has two types of searching operations: <get> and <get-config>. Although the searching objects of the two operations are different, the two operations have the same expression manners for the searching condition, that is, a subtree filtering manner and an XML Path Language (Xpath) manner.

In prior art one, in subtree filtering, the filter condition is described by using an XML manner, and through a set of simple matching rules, a data element satisfying the condition is selected. Example 1 is an example of subtree searching, <rpc> element indicates that the request is sent by a network management device, <get> element indicates that the network management device requests to execute a searching operation, and <filter> element indicates a searching manner and a searching condition, where an attribute type=“subtree” indicates that the searching adopts the subtree filtering manner, the child node of <filter> indicates that the searching intends to search a certain <interface> element in a <interfaces> element in a <top> element in a naming space “http://example.com/schema/1.2/stats”, the <interface> element needs to have an ifName attribute, and an attribute value of ifName is “eth0”.

### EXAMPLE 1

### A <Get> Request using Subtree Searching

```
<rpc message-id=“101”
    xmlns=“urn:ietf:params:xml:ns:netconf:base:1.0”>
  <get>
    <filter type=“subtree”>
      <t:topxmlns:t=“h.ttp://example.com/schema/1.2/stats”>
        <t:interfaces>
          <t:interface t:ifName=“eth0”/>
        </t:interfaces>
      </t:top>
    </filter>
</get>
</rpc>
```

The <filter> element is called a filter, and in subtree filtering, the filter is formed by zero to a plurality of element subtrees representing a selecting standard. In each layer of the subtree, the managed device performs logic judgment on each sibling node set, so as to determine whether the subtree led by each sibling node is included in an output result of the filter. All the elements occurring in the subtree of the filter need to match corresponding nodes in a server concept data model.

The filter may be divided into 5 types of components, and each type of components executes different filter rules, including naming space selection, attribute matching expression, container node, selected node, and content matching node.

Naming space selection: If the naming space is used, the output of the filter only includes the elements in the designated naming space. That is to say, the content of the “xmlns” attribute in the filter is the same as the content of the “xmlns” attribute in a data model of the managed device. In Example 1, <t:top xmlns:t=“http://example.com/schema/1.2/stats”> indicates that the selected naming space is http://example.com/schema/1.2/stats, and only the sub-elements in <top> in the naming space are output.

Attribute matching expression: The attributes occurring in the filter are a part of the attribute matching expression. In addition to matching with the nodes in the filter, the selected data needs to match with the attributes of the filter. If one element does not include the designated attribute, the element will not be selected. In Example 1, ifName=“eth0” is the attribute matching expression. The filter results output the ifName attribute, and the attribute value of ifName is the <interface> element of “eth0”, as shown in Example 2. In Example 2, the <rpc-reply> element indicates that it is a reply, and the <data> element indicates the replied data, where the naming space of the replied data, and each level of sub-element and attribute all match the corresponding parts in the filter.

### EXAMPLE 2

### The Searching Result of Attribute Matching

```
<rpc-reply message-id=“101”
    xmlns=“urn:ietf:params:xml:ns:netconf:base:1.0”>
  <data>
    <t:top xmlns:t=“http://example.com/schema/1.2/stats”>
      <t:interfaces>
<t:interface t:ifName=“eth0”>
          <t:ifInOctets>45621</t:ifInOctets>
          <t:ifOutOctets>774344</t:ifOutOctets>
        </t:interface>
      </t:interfaces>
    </t:top>
  </data>
</rpc-reply>
```

Container node: The node including the sub-element in the filter is called a container node. The sub-element of the container node may also be a container node, or other types of nodes. In Example 1, <top> is a container node, and its sub-element <interfaces> is also a container node.

Selected node: the empty node in the filter is called a selected node, which represents an explicit selection for a data model. If one of the sibling nodes of the data model is a selected node, only the subtree under the selected node is selected, and the sibling nodes of the selected node are not selected. For example, in Example 3, the <name> element is a selected node. In the data model of the managed device, if the <user> has other child nodes besides <name>, only <name> is selected, and the sibling nodes of <name> are not selected.

### EXAMPLE 3

### The Selected Node in the Filter

```
<filter type=“subtree”>
  <top xmlns=“http://example.com/schema/1.2/config”>
    <users>
      <user>
        <name/>
      </user>
    </users>
  </top>
</filter>
```

Content matching node: The leaf node including a text value is called a content matching node, which represents the selection condition of the parent node. In Example 4, the <name> element is a content matching node, which represents that all the <user> elements (and the sub-elements of the <user> elements) having <name> being “fred” are selected for being output. The searching result of the filter is as shown in Example 5.

The logic operation of “AND” is executed among a plurality of sibling content matching nodes.

### EXAMPLE 4

### The Content Matching Node in the Filter

```
<filter type=“subtree”>
  <top xmlns=“http://example.com/schema/1.2/config”>
    <users>
      <user>
        <name>fred</name>
      </user>
    </users>
  </top>
</filter>
```

### EXAMPLE 5

### Reply Output for the Content Matching Node

```
<rpc-reply message-id=“101”
    xmlns=“urn:ietf:params:xml:ns:netconf:base:1.0”>
  <data>
    <top xmlns=“http://example.com/schema/1.2/config”>
      <users>
        <user>
          <name>fred</name>
          <type>admin</type>
          <full-name>Fred Flintstone</full-name>
          <company-info>
            <dept>2</dept>
            <id>2</id>
          </company-info>
        </user>
      </users>
    </top>
  </data>
</rpc-reply>
```

To sum up, the process of the subtree filtering is generally as follows.

The output of the filter is empty at the beginning. The managed device compares the supported data model with each data branch in the filter, and if all the branches of the subtree represented by one node completely match the corresponding parts of the data model of the managed device, the node and all the child nodes are included in the result data.

The subtree filtering has the following disadvantages.

1. The subtree filtering requires more known conditions, for example, node name, node value, attribute name, attribute value, and naming space of each layer of the tree, which requires a quite excellent memory of the network manager.

2. The matching mode is single, and only exact matching is performed; otherwise, it may be considered that the data model does not have the node satisfying the filter condition. The plurality of searching conditions cannot be logically combined (AND, OR, NOT), and the scope filter (greater than, smaller than) of numerical value and time data cannot be realized.

3. The output of the filter results cannot be controlled, so as to result in redundancy and confusion. For example, when the user tries to search for the information of a certain node, in subtree filtering, all the descendants are output together, so that a great amount of unnecessary encrypted information is transmitted in the network, and it is difficult: for the user to manually find the information.

4. A mechanism for counting and processing the filter results is absent. Only the xml data is returned, so that the user cannot acquire the statistical information of the xml data, and cannot control returning manners of the entities.

In prior art two, the XPath, being the XML Path Language, is a universal language standard of searching the XML document for W3C. From the appearance, the XPath is a method for representing the searching condition of the XML document by using a file path form. For example, the subtree filtering in Example 4 is expressed by the XPath as shown in Example 6. In the example, type=“xpath” indicates that the XPath searching method is used, the value of the select attribute is an XPath expression, which indicates the searching content and the searching condition.

### EXAMPLE 6

### XPath Filter Expression

<filtertype=“xpath” select=“top/users/user[name=“fred”]”/>

The XPath mechanism is relatively complicated, and is difficult to master. Further, the XPath is expressed in a non-XML manner, and additional mechanisms are required for parsing and processing.

In the XPath, the nodes or the node sets in the XML document are selected through the path expression, and only one searching record is acquired each time, so that the user cannot realize the searching with a plurality of results for one time, and the searching efficiency is relatively low.

In the implementation of the present invention, the inventors find that the prior art has at least the following disadvantages.

The subtree filtering in prior art one is based on exact matching and absolute path, and requires the user to provide more known conditions, and lacks the mechanism for counting and processing the filter results; while the XPath mechanism in prior art two is relatively complicated, and is difficult to master.

### SUMMARY

Embodiments of the present invention provide a method and system for fuzzy searching, searching result processing and filter condition processing, thereby resolving inconvenience that a NETCONF protocol subtree filtering mechanism is limited to exact matching and absolute path only, and more known information is required in data searching; solving a problem of lacking means for searching, filtering, and processing a naming space in NETCONF protocol data model searching; enriching searching and filtering means of a subtree filtering mechanism, and improving flexibility and functionality of the subtree filtering; processing an XML filter result document acquired by the subtree filtering, and reducing redundant information processing and transmission; and modifying a filtering packet processing method with unreasonable subtree filtering parts in the NETCONF protocol.

An embodiment of the present invention provides a method for fuzzy searching based on subtree filtering. The method includes:

receiving a data flow to be filtered; and

filtering the data flow in an incomplete matching manner, and processing a filter condition in a form of character string for which a user does not give complete information.

An embodiment of the present invention further provides a method for extending a logic combination of subtree filter condition. The method includes:

receiving a data flow to be filtered; and

filtering an element type node in the data flow by adopting a plurality of attributes or a plurality of content matching nodes.

An embodiment of the present invention further provides a method for processing a subtree filtering searching result. The method includes:

setting a value of a third attribute at a corresponding node in a filter, so as to indicate whether a node descendant is shown at the node,

where the third attribute has a first value or a second value, when the third attribute indicates that all descendants of the same naming space are shown by default, the third attribute is set to the second value; and when the third attribute is set to the first value, filter results only output information of the node without outputting the descendant nodes of the same naming space.

An embodiment of the present invention further provides a filter, where the filter includes:

a receiver, configured to receive a data flow to be filtered; and

a filtering module, configured to filter the data flow in an incomplete matching manner, and process a filter condition in a form of character string for which a user does not give complete information.

An embodiment of the present invention further provides a logic filtering apparatus, where the logic filtering apparatus includes:

a receiver, configured to receive a data flow to be filtered; and

a logic filtering module, configured to filter an element type node in the data flow by adopting a plurality of attributes or a plurality of content matching nodes.

An embodiment of the present invention further provides an apparatus for processing a subtree filtering searching result. The apparatus includes:

a setting module, configured to set a value of a third attribute at a corresponding node in a filter; and

a determining module, configured to indicate, according to the value of the third attribute set by the setting module, whether a node descendant is shown at the node.

In the embodiments of the present invention, a method for searching and filtering XML network management data, expressed in an XML form, and based on a NETCONF subtree filtering mechanism, is provided, to more conveniently acquire management information in the NETCONF protocol, and prevent problems resulting from redefining a set of rules for data searching and filtering.

In the embodiments of the present invention, a mechanism for refining and combining XML data filter conditions is provided. A node in an XML document sometimes includes specific data information, and is similar to a field in a relation data base; and sometimes is only a means for encapsulating the data information, and is similar to one record in the relation data base.

In the embodiments of the present invention, a matching degree of a node is refined, and a user may select a corresponding searching method according to specific functions of the node in data storage. In addition, filter conditions expressed in the attribute and naming space manners may be combined together in a logic operation manner, so that the searching becomes more flexible.

In the embodiments of the present invention, when a filter condition is incomplete, for example, a node or an attribute name in data storage cannot be completely spelled, or a defined position of data in an XML document cannot be completely given, a subtree filtering operation may still be performed on XML data, and a result required by a user is acquired.

In embodiments of the present invention, a searching function of a naming space in subtree filtering is added, so as to help a user to quickly know the structure of data distribution in an XML document; and compensate a defect that a naming space condition needs to be given in NETCONF protocol subtree filtering, but a complete means is not provided for realizing naming space searching.

In embodiments of the present invention, special searching demands for certain data are processed, for example, scope searching with respect to time, date, number, and quantity searching with respect to data, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic view of a tree data structure in the prior art;

FIG. 2 is a structural view of a subtree filtering system in a NETCONF protocol according to an embodiment of the present invention;

FIG. 3 is an overall flow chart according to an embodiment of the present invention;

FIG. 4 is a flow chart of operation of a filter control module according to an embodiment of the present invention;

FIG. 5 is a flow chart in which filter control invokes a naming space processing component according to an embodiment of the present invention;

FIG. 6 is a flow chart of recursion process control according to an embodiment of the present invention;

FIG. 7 is a flow chart of realizing result processing according to an embodiment of the present invention;

FIG. 8 is a flow chart of a fuzzy searching method based on subtree filtering according to Embodiment 2 of the present invention;

FIG. 9 is a flow chart of a subtree filter condition logic combination extending method according to Embodiment 3 of the present invention;

FIG. 10 is a flow chart of a subtree filtering searching result processing method according to Embodiment 4 of the present invention;

FIG. 11 is a schematic structural view of a filter according to Embodiment 5 of the present invention;

FIG. 12 is a schematic structural view of a logic filtering apparatus according to Embodiment 6 of the present invention; and

FIG. 13 is a schematic structural view of a subtree filtering searching result processing apparatus according to Embodiment 7 of the present invention.

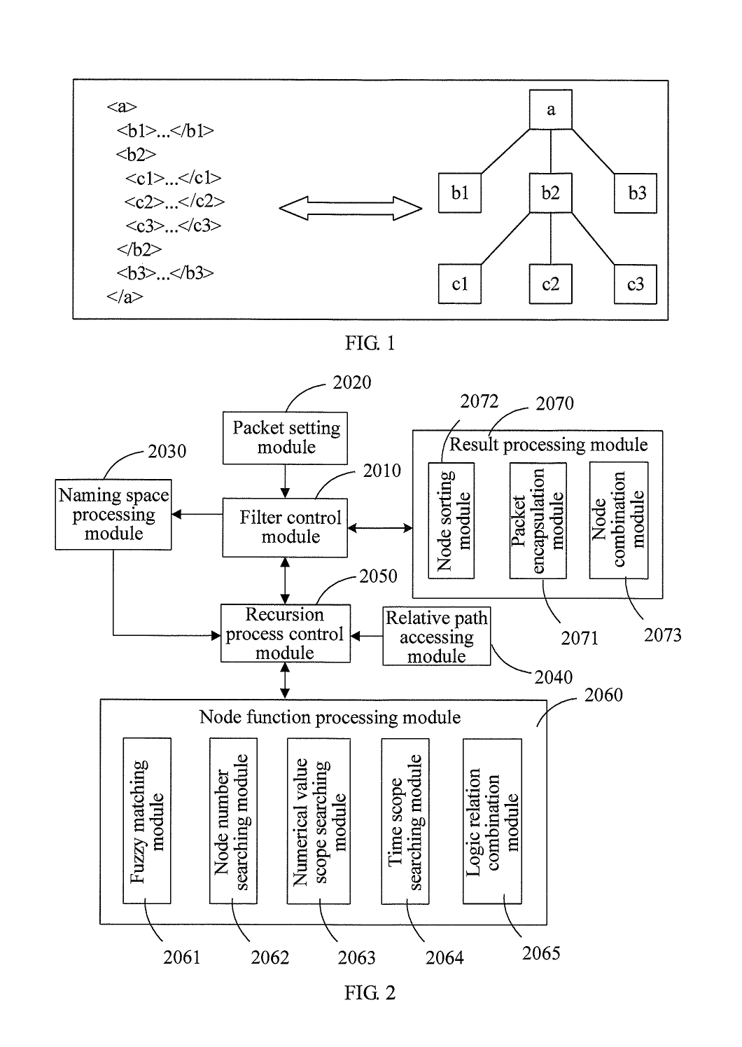

### DETAILED DESCRIPTION

In order to make the objectives, technical solutions, and advantages of the present invention more comprehensible, a detailed description of the present invention is given below with reference to some exemplary embodiments and the accompanying drawings. It should be understood that the embodiments are only used to explain the present invention instead of limiting the scope of the present invention.

An embodiment of the present invention provides a set of definition method for realizing data searching and data filtering functions for a network management information model defined by an XML language, where the definition method is based on a NETCONF protocol and in the definition method a subtree filtering mechanism in the NETCONF protocol is extended. The definition method includes a detailed description of a subtree filtering function and keyword definition relevant to function definition.

In order to be differentiated from the subtree filtering mechanism in the NETCONF protocol, in the embodiment of the present invention, a value advancedSubtree is newly added to a type attribute of a <filter> node, which represents that a request for performing an extending function of the subtree filtering mechanism may be carried.

A subtree filtering extension mechanism mainly includes the following functions.

1. Fuzzy Matching

The fuzzy matching refers to that during a filtering process, when processing matching of a node name, a node content, an attribute name, an attribute value, a naming space, and other character strings, a character string for which a user does not give complete searching information is processed in an incomplete matching manner.

For example, an XML document label has relatively strict limits on the character string, so that a fuzzy matching means of the node name, the attribute name, and other label contents is different from a fuzzy matching means of the node content, the attribute value, the naming space, and other text contents. For the label content, only a character “_” may be used to represent that the label content matches any character. For the node content, the attribute value, the naming space, and other character strings having double quotation marks, letter matching is performed or all the characters are matched by using “*”. Further, for example, “_” and “*” may be used as wildcards, where “_” is used for matching any character in the node name and the attribute name; and “*” is used for matching any character in the node value and the attribute value.

In Example 7 and Example 8: an <interface> node having a certain attribute value being Ethernet1 under a <routing> node is filtered. For example, Example 7 uses the wildcard “_” to match any attribute having the value being “Ethernet1”, during the filtering, an attribute corresponding to the attribute value being Ethernet1 and a node having the attribute are found, and the node, the attribute name, and the attribute value are output, where filter results are as shown in Example 8.

### EXAMPLE 7

### Fuzzy Matching of the Attribute Name

```
<filter type=“advancedSubtree”>
  <netconf xmlns=“*”>
      <routing>
        <interface _=“Ethernet1”/>
      </routing>
    </netconf>
    </filter>
```

### EXAMPLE 8

### Returned Results of the Fuzzy Searching of the Attribute Name

```
    <netconf xmlns=“urn:ietf:params:xml:ns:netconf:base:1.0”
  xmlns:if=“urn:bupt:pris:priser:agent:module:interface:1.0”>
      <routing>
        <if:interface  name=“Ethernet1”
ip-address=“59.64.139.65”>
        <... />
        </if:interface>
      </routing>
      </netconf>
```

In addition, if the attribute name is known but the attribute value is not known, the fuzzy searching may be used for the attribute value, and in this case, the wildcard “*” is used, as shown in Example 9.

### EXAMPLE 9

### Fuzzy Matching of the Attribute Value

```
<filter type=“advancedSubtree”>
  <netconf xmlns=“*”>
    <routing>
      <interface name=“*”/>
    <routing/>
  <netconf/>
    </filter>
```

The fuzzy searching of the node name and value is similar to that of the attribute name and value. The fuzzy searching of the value of <name> and the <name> itself may be:

<interface><name>*</name></interface>
or
<interface><_>Ethernet1</_></interface>

In addition, the fuzzy filtering of incomplete content matching may be performed on the node value, the attribute value, and the naming space content. The searching condition is that:
<interface name=“:Eth*”/>

If the XML data has a plurality of <interface> elements, and the attribute value of its name starts with “Eth”, the <interface> elements are matched and output.

2. Relative Path and Cross-Hierarchy Access

In the protocol, the subtree filtering adopts absolute path matching, that is, a root node of a filter and descendant nodes of each level need to be completely the same as that in a data model.

In order to improve filtering flexibility, a relative path matching mechanism is added, that is, the nodes in the filter only keep an ancestor-descendant relation being the same as that in the data model, but do not strictly keep a parent-child relation being the same as that in the data model. For example, in the data model, nodes A and B have a grandparent-child relation, but in the filter, the nodes A and B have a parent-child relation, although the parent nodes of B are different in the data model and the filter, the ancestor-descendant relations between A and B in the data model and the filter are the same.

In order to realize filtering through relative path, in the present invention, an attribute _nodepath is defined for the <filter> node, and the attribute has two values.

One value is “absolute”, which represents that all the nodes in the filter adopt the filtering through an absolute path, that is, the parent-child relation between each node in the filter needs to be strictly the same as the parent-child relation of each node in the data model. The value “absolute” is a default value of the attribute _nodepath.

The other value is “relative”, which represents that the filtering is performed through a relative path, that is, the nodes having the parent-child relation in the filter satisfy the ancestor-descendant relation in the data model.

For example, in Example 10 and Example 11, it intends to search the <interface> node in the data model, and since a specific position of the node in the data model is not known, the absolute path of the node cannot be given in the filter, and the filtering is performed through the relative path by using _nodepath=“relative”.

### EXAMPLE 10

### Filtering Through the Relative Path

```
<filter type=“advancedSubtree” _nodepath=“relative”>
  <interface xmlns=“*”/>
    </filter>
```

### EXAMPLE 11

### The Filter Result of the Filtering Through the Relative Path

```
      <netconf xmlns=“urn:ietf:params:xml:ns:netconf:base:1.0”
  xmlns:if=“urn:bupt:pris:priser:agent:module:interface:1.0”>
        <routing>
          <if:interface  name=“Ethernet1”
ip-address=“59.64.139.65”>
            <... />
          </if:interface>
          <if:interface  name=“Ethernet2”
ip-address=“59.64.139.69”>
            <... />
          </if:interface>
        </routing>
        </netconf>
```

If it is known that a root node of the data model at which the <interface>node is located is <netconf>, Example 10 may be varied into:

```
<filter type=“advancedSubtree” _nodepath=“relative”>
  <netconf xmlns=“*”>
      <interface/>
  </netconf>
    </filter>
```

3. Refining and Combination of Searching Condition

In the subtree filtering, a plurality of attribute expressions or a plurality of content matching nodes may be adopted as the filter conditions for performing filtering. However, a relation among the plurality of filter conditions can only be “AND”.

In order to improve the flexibility of setting the filter conditions, another two logic relations, OR and NOT, are added, and matching degrees of the filter conditions defined in the element type node manner are divided in detail.

3.1 Logic Relation Among Filter Conditions of the Element Type Nodes

In the present invention, the matching degree of the node is represented by adding an attribute _matchType in each content matching node, and logic relation combination among the filter conditions of the nodes is indirectly realized in a certain degree.

The attribute _matchType has three values.

One is “must”, which represents that only when the content matching node completely matches the corresponding node in the data model, is the parent node added into the filter result. It is a default value of the attribute _matchType.

One is “may”, which represents that if the content matching node completely matches the corresponding node in the data model, the parent node of the content matching node is added into the filter result; if not matching, the content matching node is ignored, and the situations of other content matching nodes in the filter are checked.

The last one is “not”, which represents that only when the content matching node does not match the corresponding node in the data model, the parent node is added into the filter result.

### EXAMPLE 12

### The <Interface>Element is Searched, Where the <Interface> Element Satisfies the Condition that the <Name> is Ethernet1, and <Received> is 49

```
<filter type=“advancedSubtree”>
  <netconf xmlns=“*”>
      <routing>
        <interface>
            <name _matchType=“mustn”>Ethernet1</name>
            <received _matchType=“must”>49</received>
        </interface>
      </routing>
  </netconf>
</filter>
```

In Example 12, both of the two content matching nodes <name> and <received> use _matchType=“must”, which indicates that only when the searching conditions indicated by the two nodes are satisfied at the same time, is the <interface> node output.

If the searching condition is changed, and it intends to acquire the <interface> element having <name> being Ethernet1 or <received> being 49, —matchType=“may”, as shown in Example 13.

### Example 13

### Realization of the “OR” Logic Relation Between the Content Matching Nodes

```
<filter type=“advancedSubtree”>
  <netconf xmlns=“*”>
      <routing>
        <interface>
            <name _matchType=“may”>Ethernet1</name>
            <received _matchType=“may”>49</received>
        </interface>
      </routing>
  </netconf>
</filter>
```

Example 14 demonstrates an example of _matchType=“not”, where the searching intends to output the <interface> node having <name> being not Ethernet1.

### EXAMPLE 14

### “NOT” Filter Condition of the Content Matching Node

```
<filter type=“advancedSubtree”>
  <netconf xmlns=“*”>
      <routing>
        <interface>
            <name _matchType=“not”>Ethernet1</name>
        </interface>
      </routing>
  </netconf>
</filter>
```

3.2 Logic Relation Filtering of the Node Attribute and the Naming Space

The logic relation among a plurality of attributes of the node may be represented by adding an attribute _attrLogic into the node. The logic relation among the naming spaces may be represented by adding an attribute _nsLogic. A value of the attribute _attrLogic is a logic expression. The logic expression may use the following logic operators:

̂, logic “AND” operation;

| |, logic “OR” operation;

!, logic “NOT” operation; and

( ), change the operation priority.

The logic expression of the attribute _nsLogic may only use the logic “OR” operation. The object participating in the logic operation in the logic expression is an attribute name or a naming space prefix.

If the attribute _attrLogic does not occur in the node, it is considered by default that the relation between each attribute is “AND”. That is to say, the description of the following two conditions is the same:

```
        <interface name=“Ethernet1” ip-address=“59.64.139.69”/>
        <interface  name=“Ethernet1” ip-address=“59.64.139.69”
_attrLogic=“name\hat{ }ip-address”/>
```

If the filter condition is modified, the <interface> node having the name attribute value being not “Ethernet1” or the ip-address attribute value being “59.64.139.69” is searched, where the expression manner of the searching condition is that:

<interface name=“Ethernet1” ip-address=“59.64.139.69”
_attrLogic=“!name ||ip-address”/>

The usage of the logic relation of the naming space is similar to the attribute, except that only the “OR” operation can be performed, as shown in Example 15.

### EXAMPLE 15

### Searching of Multiple Naming Spaces of the Node

```
        <filter type=“advancedSubtree”>
          <netconf xmlns=“*”>
            <routing>
                <interface
xmlns:if=“urn:bupt:pris:priser:agent:module:interface:1.0”
    xmlns:mt=“urn:bupt:pris:priser:agent:module:monitor:1.0”
_nsLogic=“if||mt”/>
            <routing/>
          <netconf/>
        </filter>
```

4. Searching of Naming Space

The searching of the naming space may acquire the definition situation of the naming space in the data model, and gives a naming space list. The keyword of the searching of the naming space is a label element <_xmlns>, and when the child node of the filter <filter> is <_xmlns>, it represents that the relevant searching of the naming space is performed on the data model; <_xmlns> has an attribute prf, and an attribute value of <_xmlns> is a corresponding prefix of the naming space in the XML document, while if the naming space is a default naming space (that is, without the prefix), the prf attribute is not output.

For example, Example 16 and Example 17 respectively show the definition of the filter and the filter result of searching all the naming spaces in the data model.

### EXAMPLE 16

### Searching of All Naming Spaces

<filter type=“advancedSubtree”>
<_xmlns/>
</filter>

### EXAMPLE 17

### The Filter Result of Example 16

```
          <data>
            <_xmlns>
urn:ietf:params:xml:ns:netconf:base:1.0</_xmlns>
            <_xmlns  prf=“if”>
urn:bupt:pris:priser:agent:module:interface:1.0</_xmlns>
            <_xmlns  prf=“mt”>
urn:bupt:pris:priser:agent:module:module:1.0</_xmlns>
          </data>
```

In Example 16, through the keyword element <xmlns>, the filter is notified of searching all the naming spaces existing in the data model. In the filter result, all the naming spaces in the data model are returned in a form of <_xmlns> urn:ietf:params:xml:ns:netconf:base:1.0</xmlns>.

In addition, the naming spaces of a part of the data model may be searched, as shown in Example 18.

### EXAMPLE 18

### Searching of Naming Spaces of a Part of Elements

```
<filter type=“advancedSubtree”>
  <_xmlns>
      <netconf>
        <routing/>
      </netconf>
  </_xmlns>
</filter>
```

The filter result is that:

| | |
|---|---|
| <_xmlns | prf=“if”> |

urn:bupt:pris:priser:agent:module:interface:1.0</_xmlns>

In the example, <filter> notifies, by setting the child node <_xmlns>, the filter of searching the naming space of the data model, and notifies, by setting a node <netconf><routing/></netconf>, the filter of specifically searching the naming space of a subtree /netconf/routing, so that in the filter result, only the naming space “urn:bupt:pris:priser:agent:module:interface:1.0” of the nodes <netconf> and <routing> in the data model is returned.

5. Control of Descendant Output.

When the filter gives a selected node or a container node, the filter result outputs the node and all the descendants; and sometimes, the descendant nodes are not: required.

In order to improve the filtering efficiency and facilitate the acquiring of the desired information by the user, an attribute _show is set at the corresponding node in the filter, to indicate whether to output the node descendants. The attribute has the following two values.

One value is “self”, which represents that the filter result only outputs the information of the node, but not outputs the descendant nodes.

The other value is “descendant”, which represents that the filter result outputs the node and all the descendant nodes, and “descendant” is a default value of the attribute _show.

For example, Example 19, Example 20, Example 21, and Example 22 respectively show how to filter the complete information and a part of the information of the designated node.

### EXAMPLE 19

### Filter Outputting the Complete Information of the Node

<filter type=“advancedSubtree” _nodepath=“relative”>
<interface _show=“descendant”/>
</filter>

### EXAMPLE 20

### The Filter Result of Example 19

```
    <netconf xmlns=“urn:ietf:params:xml:ns:netconf:base:1.0”
xmlns:if=“urn:bupt:pris:priser:agent:module:interface:1.0”>
      <routing>
        <if:interface name=“Ethernet1”
ip-address=“59.64.139.65”>
          <... />
        </if:interface>
        <if:interface name=“Ethernet2”
ip-address=“59.64.139.69”>
          <... />
        </if:interface>
      </routing>
    </netconf>
```

### EXAMPLE 21

### Only the Information of the Node is Output

<filter type=“advancedSubtree” _nodepath=“relative”>
<interface _show=“self”/>
</filter>

### EXAMPLE 22

### The Filter Result of Example 21

```
    <netconf xmlns=“urn:ietf:params:xml:ns:netconf:base:1.0”
  xmlns:if=“urn:bupt:pris:priser:agent:module:interface:1.0”>
      <routing>
        <if:interface name=“Ethernet1”
ip-address=“59.64.139.65”/>
        <if:interface name=“Ethernet2”
ip-address=“59.64.139.69”/>
      </routing>
    </netconf>
```

In comparison with Example 20 and Example 22, it is apparent that when the attribute _show=“self” is set in the node <interface> in the filter <filter>, only the information of the node is output, thereby preventing from returning excessive redundant information, and improving the filtering efficiency.

6. Number Searching

Through the number searching function, the number of a certain type of elements in the data model, that is, the number of the elements corresponding to the same filter node, may be counted. The function is realized by using the _count attribute in a certain element type node in the filter, where values of the attribute are “true” and “false”. When the value of the _count attribute is set to be “true”, the filter result outputs the number of the searching entities; and when the _count attribute is set to be “false”, the filter result does not output the number of the searching entities, where “false” is a default value of the attribute _count. If the filter result returns the number of the searching entities, the label element <_countNum> is added under the corresponding entity element type node in the filter result, where a text value of the element identifies the number of the searching entities.

For example, Example 23 and Example 24 show how to search the number of the child nodes <configuration> of the <monitor> node, where the filter and the filter result are as follows.

### EXAMPLE 23

### Searching of the Number of the Designated Nodes

```
    <filter type=“advancedSubtree”>
      <netconf xmlns=“*”>
        <monitor
xmlns=“urn:bupt:pris:priser:agent:module:monitor:1.0”>
          <configuration _count=“true”/>
        </monitor>
      </netconf>
    </filter>
```

### EXAMPLE 24

### The Filter Result of Example 23

```
    <netconf>
      <monitor
xmlns=“urn:bupt:pris:priser:agent:module:monitor:1.0”>
        <configuration>
          <_countNum>3</_conutNum>
        </configuration>
      </monitor>
    </netconf>
```

Other conditions may be added for the searching of the number, for example, the number of the <interface> nodes having the attribute name=“Ethernet1”, or the number of the <configuration> nodes having the node value being running-state is searched. The searching is as follows:

<interface name=“Ethernet1” _count=“true”>
<configuration _count=“true”>running-state</running>

7. Scope Condition

In the present invention, an attribute representing the scope is added into the selected node representing the number or the time, and the selected node is considered as the content matching node representing the time or the number scope, so as to be used as the filter condition during the filtering process.

The attribute keywords representing the number scope are as follows.

“_morethan” represents that the value of the selected node having the attribute is greater than the value of the attribute.

“_lessthan” represents that the value of the selected node having the attribute is smaller than the value of the attribute.

“_notmorethan” represents that the value of the selected node having the attribute is not greater than the value of the attribute.

“_notlessthan” represents that the value of the selected node having the attribute is not smaller than the value of the attribute.

The attribute keywords representing the time scope are as follows.

“_timebefore” represents that the time value of the selected node having the attribute is earlier than the value of the attribute.

“_timeafter” represents that the time value of the selected node having the attribute is later than the value of the attribute.

“_timenotbefore” represents that the time value of the selected node having the attribute is equal to or later than the value of the attribute.

“_timenotafter” represents that the time value of the selected node having the attribute is equal to or earlier than the value of the attribute.

For example, it intends to search the <interface> node having the value of <received> being greater than 12 and smaller than 25, the filter expression is as shown in Example 25, where <received _morethan=“12” _lessthan=“25”/> indicates the scope condition. Example 26 shows the searching result.

### EXAMPLE 25

### Filter Performing the Filtering of the Numerical Value Scope

```
    <filter type=“advancedSubtree”>
      <netconf xmlns=“urn:ietf:params:xml:ns:netconf:base:1.0”
xmlns:if=“urn:bupt:pris:priser:agent:module:interface:1.0”>
        <routing>
          <if:interface>
            <received _morethan=“12” _lessthan=“25”/>>
          </if:interface>
        </routing>
      </netconf>
    </filter>
```

### EXAMPLE 26

### The Filter Result of Example 25

```
    <netconf xmlns=“urn:ietf:params:xml:ns:netconf:base:1.0”
    xmlns:if=“urn:bupt:pris:priser:agent:module:interface:1.0
”>
      <routing>
        <if:interface name=“Ethernet1”
ip-address=“59.64.139.65”>
          <if:received>19</if:received>
          <... />
        </if:interface>
      </routing>
    </netconf>
```

In the following, an example of performed searching according to the time scope condition is shown.

<startTime _timenotafter=“2007-07-01 05:24:06”
_timeafter=“2007-06-30 05:24:06”/>

It represents that the <startTime> node having the time being later than but not including 05:24:06 of Jun. 30, 2007, and earlier than 05:24:06 of Jul. 1, 2007 is searched.

Alternatively, a character string matching function is added.

<startTime _timeafter=“2005-06-30
05:24:06”>*-07-*</startTime>

Only the expression of month satisfies the format of -07-, so the definition may be used to search the relevant data of July in each year after 05:24:06 of Jun. 30, 2005.

8. Subtree Sorting and Combining

The filter results acquired by the same filter node are sorted as requires, for example, are sorted in an ascending order or a descending order according to a certain node content, and the nodes having completely the same content in the searching results are combined.

The sorting is realized by setting attributes _ascOrder and _descOrder at the root node of the subtree to be sorted. The attribute _ascOrder represents that the filter results are sorted in the ascending order according to a certain node or attribute, and the attribute _descOrder represents that the filter results are sorted in the descending order according to a certain node or attribute. Values of the two attributes are the node name or the attribute name used as the reference for sorting. The node used as the reference for sorting should have the value, and is the child node of the node having the attribute. When the sorting is performed according to the attribute, “@” needs to be added before the attribute name, so as to identify that it is an attribute name. The node value is used as an index for sorting, and the filter results are sorted in a text manner by default; if the filter results are sorted according to the numerical value, an identifier “(n)” is added after the node or the attribute name, for example, _ascOrder=“received(n)”; and if the value of the node or the attribute is the non-numerical value type, error information is returned to the user.

When it is necessary to perform sorting according to a plurality of nodes and attributes, “̂” is connected among the plurality of node names and attribute names, and the node and the attribute name sorted in the front have a priority higher than that of the node and the attribute name sorted in the back.

For example, it intends to output the <interface> nodes in the descending order according to the value of the <name> node, and the <interface> nodes having the same <name> value are sorted according to an ip attribute. The searching is as shown in Example 27, where _descOrder=“namê@ip” expresses the sorting demand. Example 43 shows the sorting result.

### EXAMPLE 27

### The Element is Output in the Descending Order According to the Designated Node Value

```
    <filter type=“advancedSubtree”>
      <netconf
xmlns=“urn:ietf:params:xml:ns:netconf:base:1.0”>
          <routing>
            <interface
xmlns=“urn:bupt:pris:priser:agent:module:interface:1.0”
                _descOrder=“name \hat{ } @ip”/>
        </routing>
      </netconf>
    </filter>
```

### EXAMPLE 28

### The Filter Result of Example 27 is Shown as Follows

```
    <netconf xmlns=“urn:ietf:params:xml:ns:netconf:base:1.0”
  xmlns:if=“urn:bupt:pris:priser:agent:module:interface:1.0”
  xmlns:mt=“urn:bupt:pris:priser:agent:module:monitor:1.0”>
      <routing>
        <if:interface name=“Ethernet2”
ip-address=“59.64.139.69”>
          <if:name>Ethernet2</if:name>
          ...
        </if:interface>
        <if:interface name=“Ethernet1”
ip-address=“59.64.139.65”>
          <if:name>Ethernet1</if:name>
          ...
        </if:interface>
      </routing>
    </netconf>
```

Many subtrees having the same structure and the same content may be acquired for the same filter node, so that an attribute _merge is set at the root node of the subtree to be sorted, so as to realize the combination of the same subtrees. A value of the attribute is “true” or “false”. When _merge=“true”, it represents that the filter results are returned after the combination of the same subtrees is performed thereon; and when _merge=“false”, it represents that the combination of the same subtrees is not performed on the filter results, and a default value of the attribute merge is “false”.

It is assumed that the <interface> node in the data model does not have any attribute, for the message as follows:

### EXAMPLE 29

### The Combined Filter is Not Used

```
    <filter type=“advancedSubtree”>
      <netconf
xmlns=“urn:ietf:params:xml:ns:netconf:base:1.0”>
        <routing>
          <interface
xmlns=“urn:bupt:pris:priser:agent:module:interface:1.0”
_show=“self”/>
        </routing>
      </netconf>
    </filter>
```

### EXAMPLE 30

### The Combined Filter Result is Not Used

```
    <netconf xmlns=“urn:ietf:params:xml:ns:netconf:base:1.0”
xmlns:if=“urn:bupt:pris:priser:agent:module:interface:1.0”
xmlns:mt=“urn:bupt:pris:priser:agent:module:monitor:1.0”>
      <routing>
        <if:interface/>
        <if:interface/>
      </routing>
    </netconf>
```

Here, actually the user only wants to know whether the interface node exists in the data model, and not cares about others. If the _merge attribute is used, the <interface> node is modified as:

<interface
xmlns=“urn:bupt:pris:priser:agent:module:interface:1.0”
_show=“self” _merge=“true”/>

The filter result is as shown in Example 31.

### EXAMPLE 31

### The Combined Filter Result

```
        <netconf xmlns=“urn:ietf:params:xml:ns:netconf:base:1.0”
xmlns:if=“urn:bupt:pris:priser:agent:module:interface:1.0”
xmlns:mt=“urn:bupt:pris:priser:agent:module:monitor:1.0”>
          <routing>
            <if:interface/>
          </routing>
        </netconf>
```

A plurality of same <interface> nodes (or subtrees) is compressed and only one is output, which may prevent the problem that a great amount of redundant information is transmitted in the management network, when the data model has a great many nodes with the same name.

To sum up, the definition rules of the extending function in the present invention are concluded as shown Table 1.

TABLE 1
Definition of subtree filtering functions

| Realized | Realizing | | | |
|---|---|---|---|---|
| Function | Method | Identifier | Value | Usage/Definition |
| Subtree | To extend a | type | advancedSubtree | Indicate that an |
| filtering | new value for | | | advanced subtree |
| extension | the type | | | filtering mode of |
| | attribute of | | | the present |
| | the <filter> | | | invention is |
| | node | | | adopted |
| Fuzzy | To define a | — | | Match with any |
| matching | wildcard, | | | node and |
| | which matches | | | attribute name |
| | with any | * | | Match with any |
| | character in | | | character in the |
| | the element | | | naming space, |
| | name, element | | | node value, and |
| | value, | | | attribute value |
| | attribute | | | |
| | name, | | | |
| | attribute | | | |
| | value, and | | | |
| | naming space | | | |
| Path | To extend a | _nodepath | absolute | The path of the |
| matching | new attribute | | | node is strictly |
| | for the | | | matched |
| | <filter>node | | | according to the |
| | | | | absolute path. |
| | | | | The value |
| | | | | “absolute” is a |
| | | | | default value of |
| | | | | the attribute. |
| | | | relative | The path of the |
| | | | | node is not |
| | | | | matched |
| | | | | according to the |
| | | | | absolute path. |
| Logic | To extend a | _matchType | must | The plurality of |
| relation of | new attribute | | | content matching |
| the content | for the | | | nodes has the |
| matching | content | | | “AND” relation. |
| node | matching node | | | The value “must” |
| | | | | is a default value |
| | | | | of the attribute. |
| | | | may | The plurality of |
| | | | | content matching |
| | | | | nodes has the “OR” |
| | | | | relation. |
| | | | not | The “NOT” |
| | | | | operation is |
| | | | | performed on the |
| | | | | content matching |
| | | | | node having the |
| | | | | attribute. |
| Logic | To extend a | _attrLogic | The logic | The attribute of |
| relation | new attribute | | expression of the | the filtered node |
| among the | for the node | | attribute of the | should satisfy |
| attributes | executing the | | node, and the logic | the logic |
| | attribute | | operators include | expression. |
| | filtering | | \hat{ }, \|\|, !, (,). | |
| Logic | To extend a | _nsLogic | The logic | The filtered node |
| relation of | new attribute | | expression of the | belongs to the |
| the naming | for the | | prefix of the | naming space |
| space | element type | | naming space, and | indicated by the |
| | node | | the logic operator | logic |
| | | | includes \|\|. | expression. |
| Searching | To extend a | <_xmlns> | Have no child node, | The naming space |
| of the | new element | | or the child node is | to which the |
| naming | | | a subtree. | subtree belongs |
| space | | | | is searched. |
| Descendant | To extend a | _show | self | Only the node |
| output | new attribute | | | having the |
| control | for the | | | attribute is |
| | selected node | | | output. |
| | and the | | descendant | The node having |
| | container | | | the attribute and |
| | node | | | the descendants |
| | | | | of the node are |
| | | | | output. The value |
| | | | | “descendant” is a |
| | | | | default value of |
| | | | | the attribute. |
| Number | To extend a | _count | true | The number of |
| searching | new attribute | | | nodes satisfying |
| | for the | | | the filter |
| | element type | | | condition is |
| | node | | | searched. |
| | | | false | The content of |
| | | | | nodes satisfying |
| | | | | the filter |
| | | | | condition is |
| | | | | searched. The |
| | | | | value “false” is a |
| | | | | default value of |
| | | | | the attribute. |
| | To extend a | <_countNum> | The number of the | Being a |
| | new attribute | | nodes, and being a | sub-element of |
| | for searching | | positive integer | the <data> |
| | the replied | | | element, and |
| | result | | | carrying the |
| | | | | number of the |
| | | | | matched nodes. |
| Filtering | To extend a | _morethan | Numerical value | The node value is |
| of | new attribute | | | greater than a |
| numerical | for the | | | numerical value. |
| value scope | numerical | _lessthan | Numerical value | The node value is |
| | value data | | | smaller than a |
| | type element | | | numerical value. |
| | | _notmorethan | Numerical value | The node value is |
| | | | | smaller than or |
| | | | | equal to a |
| | | | | numerical value. |
| | | _notlessthan | Numerical value | The node value is |
| | | | | greater than or |
| | | | | equal to a |
| | | | | numerical value. |
| Filtering | To extend a | _timebefore | The character | Earlier than a set |
| of time | new attribute | | string satisfying | time |
| scope | for the time | | the time standard | |
| | data type | | expression | |
| | element | _timeafter | The character | Later than a set |
| | | | string satisfying | time |
| | | | the time standard | |
| | | | expression | |
| | | _timenotbefore | The character | Equal to or later |
| | | | string satisfying | than a set time |
| | | | the time standard | |
| | | | expression | |
| | | _timenotafter | The character | Equal to or |
| | | | string satisfying | earlier than a set |
| | | | the time standard | time |
| | | | expression | |
| Subtree | To extend a | _ascOrder | Being the name of a | Sorted in the |
| sorting | new attribute | | descendant node of | ascending order |
| | for the node | | the node, so as to | according to the |
| | | | be connected with | node having the |
| | | | the operator “\hat{ }” | attribute |
| | | _descOrder | Being the name of a | Sorted in the |
| | | | descendant node of | descending order |
| | | | the node, so as to | according to the |
| | | | be connected with | node having the |
| | | | the operator “\hat{ }” | attribute |
| Subtree | To extend a | _merge | true | Completely the |
| combination | new attribute | | | same nodes are |
| | for the node | | | combined. |
| | | | false | Completely the |
| | | | | same nodes are not |
| | | | | combined. |

The keyword with “< >” represents that the keyword exists in an element form; the keyword without “< >” but with “_” represents that the keyword exists in an attribute form; and the keyword without the two symbols represents that the keyword exists in the form of an attribute value or a node value.

In addition, in the present invention, the following processing situations in the NETCONF protocol subtree filtering mechanism are modified.

1. Discard the Ancestor of the Not Matching Node

If a filter request as described in the following example exists:

### EXAMPLE 32

### Searching of the Not Matching Node

```
<filter type=“subtree”>
            <netconf
xmlns=“urn:ietf:params:xml:ns:netconf:base:1.0”>
              <routing>
                <interface name=“Ethernet”
xmlns=“urn:bupt:pris:priser:agent:module:interface:1.0”/>
              <routing/>
            <netconf/>
        </filter>
```

The data model does not have an interface node having the value of the attribute name being Ethernet. In the NETCONF protocol subtree filtering mechanism, the filter result acquired in the NETCONF protocol is as follows.

### EXAMPLE 33

### The Filter Result of the Not Matching Node in the NETCONF Protocol

```
        <data>
        <netconf xmlns=“urn:ietf:params:xml:ns:netconf:base:1.0”
xmlns:if=“urn:bupt:pris:priser:agent:module:interface:1.0”
xmlns:mt=“urn:bupt:pris:priser:agent:module:monitor:1.0”>
            <routing/>
        </netconf>
        </data>
```

In the data model, the matching interface node does not exist, so that the interface node is not output, but the ancestors routing and netconf are returned. For the user, the definition expression of the filter result is implicit, and causes redundant information.

In the present invention, when all the nodes to be matched are discarded for having no matching node in the data model, the parent node of the discarded nodes is also not returned. Therefore, the filtering of Example 32 returns an empty filter result.

<data></data>

2. Filter the Naming Space

The subtree filtering mechanism in the NETCONF protocol gathers and processes the nodes having the same parent node (that is, the sibling node set), from the root node to the leaf nodes. Therefore, once the matching fails, the not matching node and all the child nodes of the not matching node are deleted. For example, the filter request in the NETCONF protocol is as follows.

### EXAMPLE 34

### Filtering of the Naming Space in the NETCONF Protocol

```
            <filter type=“subtree”>
              <netconf
xmlns=“urn:bupt:pris:priser:agent:module:interface:1.0”/>
            </filter>
```

When the root node netconf is processed, the node name is matched, but the naming space is not matching, the netconf node is discarded, so as to acquire an empty filter result.

### EXAMPLE 35

### The Filter Result of the Naming Space in the NETCONF Protocol

<data></data>

In the embodiments of the present invention, when the naming space in which the node is located is not matching, the child nodes of the node are continuously processed, for the reason that the descendant of the node may be matched with the given naming space. Meanwhile, to ensure the validity of the hierarchy relation of the filter results, the elements having the not matching naming spaces maybe used as the paths for other nodes. The user may clearly distinguish the elements having other naming spaces from the filter results.

### EXAMPLE 36

### The Filter Result Acquired by Example 34 from the Subtree Filtering Function Extension

```
            <netconf xmlns=“urn:ietf:params:xml:ns:netconf:base:1.0”
xmlns:if=“urn:bupt:pris:priser:agent:module:interface:1.0”
xmlns:mt=“urn:bupt:pris:priser:agent:module:monitor:1.0”>
              <routing>
                <if:interface  name=“Ethernet1”
ip-address=“59.64.139.65”>
                  ...
                </if:interface>
                <if:interface  name=“Ethernet2”
ip-address=“59.64.139.69”>
                  ...
                </if:interface>
              </routing>
            </netconf>
```

After the mechanism is realized, all the elements belonging to a certain naming space in a document or under a certain node may be easily found. For example, the elements in the naming space “urn:bupt:pris:priser:agent:module:interface:1.0” are searched, and the naming space is directly used as the naming space of the root node in the filter, although the naming space in the data model is different from that of the root node.

An embodiment of the present invention provides a set of processing system for realizing data searching and data filtering function for a network management information model defined by an XML language, where the processing system is based on a NETCONF protocol and in the processing system a subtree filtering mechanism in the NETCONF protocol is extended. The processing system gives a detailed description of an overall implementing structure of the system and specific functions of each module in the structure.

FIG. 2 is a structural view of a subtree filtering system in a NETCONF protocol according to an embodiment of the present invention. Referring to FIG. 2, the main system architecture of the extended NETCONF subtree filtering system according to the present invention includes a filter control module, a packet setting module, a naming space processing module, a relative path accessing module, a recursion process control module, a node function processing module, and a result processing module.

Main functions of each module are as follows.

1. Filter Control Module 2010

The filter control module 2010, serving as a core of the entire subtree filtering part, is configured to provide a control mechanism for the entire subtree filtering process, and execute protocol subtree filtering and XPath filtering operations according to parameters in the packet. The module parses the filtering relevant part in the rpc packet, and invokes other modules in sequence according to specific content of the packet for completing corresponding functions. After the corresponding module functions are completed, a processing result needs to be reported to the module. Then, the filter control module 2010 determines the operation of the next step. After the initial filter result is acquired, if the packet requires processing the filter result, the filter control module 2010 invokes the result processing module 2070 to process the initial filter result, and acquires and returns the final filter result.

2. Packet Setting Module 2020

That is, the rpc packet, including filter information required by the filter control module 2010. The filter control module 2010 firstly judges the correctness of the rpc packet, and if the rpc packet is correct, the filter control module 2010 sets specific parameters according to the information of the packet, where the parameters include a filter type (subtree filtering, extended subtree filtering, and Xpath) and whether the relative path matching is required in the extended subtree filtering, and returns a result to the filter control module 2010.

3. Naming Space Processing Module 2030

The naming space processing module 2030 is configured to process an operation request relevant to the searching of the naming space, for example, the searching of the naming spaces of all the nodes in the configuration document, and the searching of the naming spaces of all the nodes in a certain subtree. During the implementation, the recursion process control module 2050 and the result processing module 2070 are required for supporting.

4. Relative Path Accessing Module 2040

The relative path accessing module 2040 is configured to filter the configuration document, when the rpc message gives the relative path of the node. Therefore, the limit that the complete path of the node needs to be given under the protocol may be prevented, and the filtering maybe performed under the situation of not giving the complete path of the node. The main function of the module is to find an appropriate configuration document node as the parameter for the recursion process control module 2050.

5. Recursion Process Control Module 2050

The configuration document is divided from a top layer to a bottom layer, a group of sibling nodes in the filter are processed at one time, and the nodes are divided into container nodes, selected nodes, and content matching nodes for relevant processing; and whenever a node is added to the filter result, the node function processing is performed.

6. Node Function Processing Module 2060

The node function processing module 2060 includes a fuzzy matching module 2061, a node number searching module 2062, a numerical value scope searching module 2063, a time scope searching module 2064, and a logic relation combination module 2065, and is configured to compare the node in the filter document and the node in the data model during the filtering process, and give a judgment result.

7. Result Processing Module 2070

The result processing module 2070 operates the filter result, and specifically includes a packet encapsulation module 2071, a node sorting module 2072, and a node combination module 2073. When the filter filters the naming space, the result processing module 2070 needs to encapsulate the filter result, and returns all the naming spaces after encapsulating the naming spaces in an xml format. When the filter packet requires sorting the filter results, the result processing part processes the initial result according to the keyword of the sorting, acquires the sorted result, and submits the result to the filter control module 2010. The combination of the nodes is for combining the same subtrees in the initial filter result.

An embodiment of the present invention provides a set of processing method for realizing data searching and data filtering function for a network management information model defined by an XML language, where the processing method is based on a NETCONF protocol and in the processing method a subtree filtering mechanism in the NETCONF protocol is extended. The processing method includes a detailed flow chart of an overall implementing process of the NETCONF subtree filtering and specific modules.

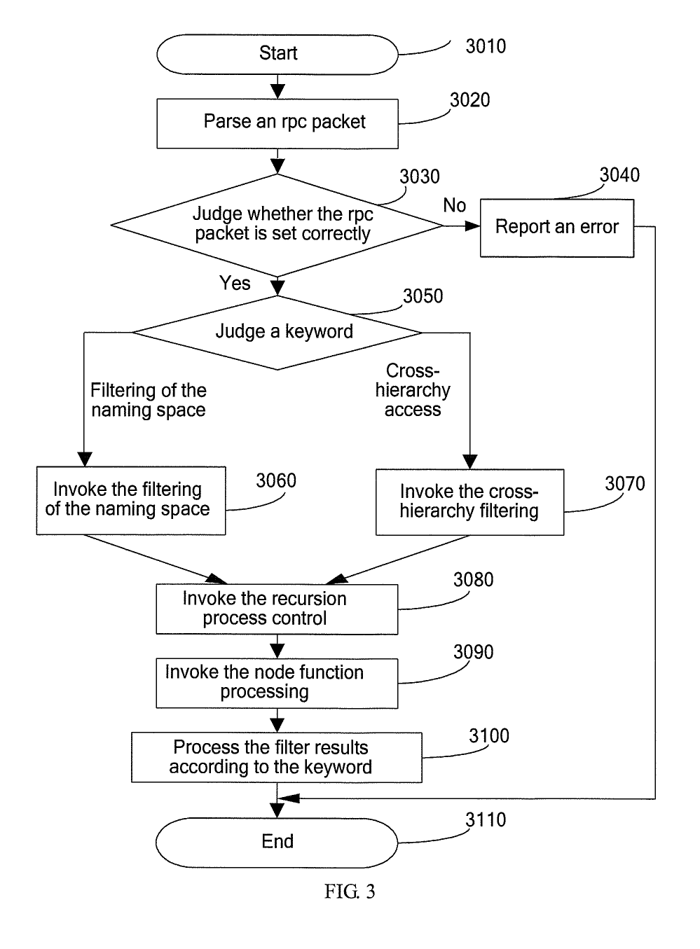

FIG. 3 is an overall flow chart of an embodiment of the present invention, which mainly includes: detecting packet errors, setting operation parameters according to a keyword, filtering a data model locally reserved by a given filter for a device (agent), invoking the node processing module when encountering a node, and after all the nodes are processed, further processing the filter results. The process includes the following steps.

In step 3010, the process starts.

In step 3020, an rpc packet is parsed.

In step 3030, it is judged whether the rpc packet is set correctly, and if the rpc packet is set correctly, the process proceeds to step 3050; the rpc packet is not set correctly, the process proceeds to step 3040.

In step 3040, an error is reported, and the process proceeds to step 3110.

In step 3050, a keyword is judged to determine whether it is the filtering of the naming space or the cross-hierarchy access; if it is the filtering of the naming space, the process proceeds to step 3060, and if it is the cross-hierarchy access, the process proceeds to step 3070.

In step 3060, the filtering of the naming space is invoked, and the process proceeds to step 3080.

In step 3070, the cross-hierarchy filtering is invoked, and the process proceeds to step 3080.

In step 3080, a recursion process control is invoked.

In step 3090, a node function processing is invoked.

In step 3100, the filter results are processed according to the keyword.

In step 3110, the process ends.

1. Filter Control

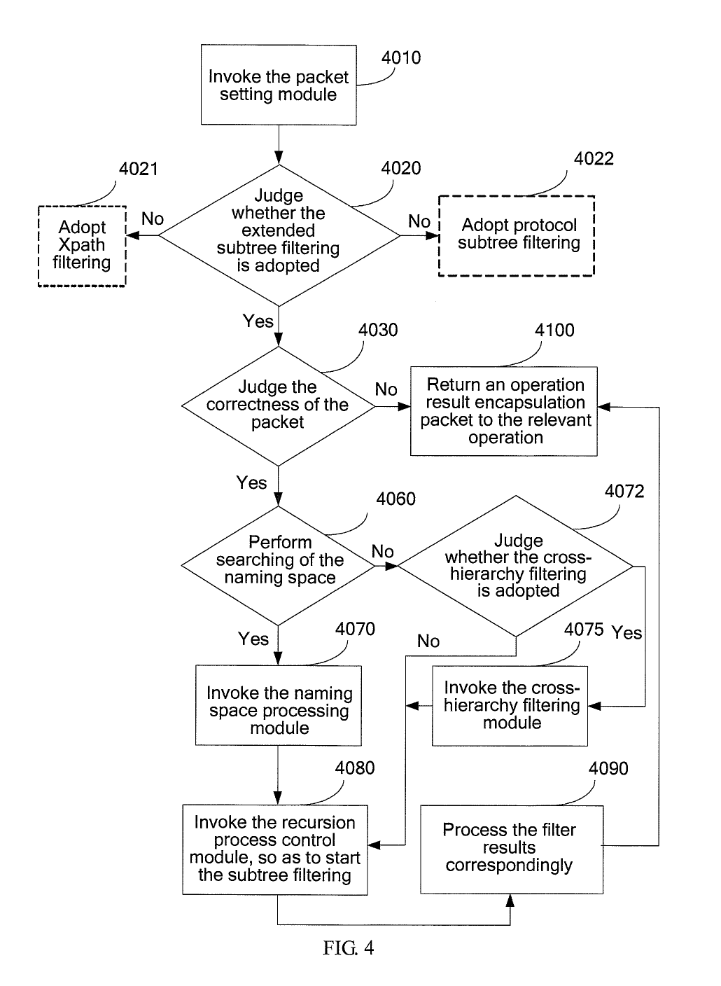

The filter control module, serving as a manager of the entire subtree filtering process, is configured to invoke other components to complete working, and receive working results of the other components to determine the working plan of a next step. FIG. 4 is a flow chart of operation of the filter control module according to an embodiment of the present invention. Referring to FIG. 4, the process includes the following steps.

In step 4010, the packet setting module in FIG. 2 is invoked.

In step 4020, it is judged whether the extended subtree filtering is adopted, and if the extended subtree filtering is adopted, the process proceeds to step 4030; the extended subtree filtering is not adopted, it is judged whether the types of the searching objects are configuration data in different configuration data storages, and if the types of the searching objects are configuration data in different configuration data storages, step 4021 is performed, where Xpath filtering is adopted; if the types of the searching objects are not configuration data in different configuration data storages, step 4022 is performed, where it is judged whether the types of the searching objects are configuration and status data being currently operated, and if the types of the searching objects are configuration and status data being currently operated, the protocol subtree filtering is adopted.

In step 4030, the correctness of the packet is judged according to the rpc packet, and if the packet is correct, the process proceeds to step 4060; if the packet is not correct, the process proceeds to step 4100.

In step 4060, the searching of the naming space is performed, and if the naming space is found the process proceeds to step 4070; if the naming space is not found, the process proceeds to step 4072.

In step 4070, the naming space processing module is invoked, and the process proceeds to step 4080.

In step 4072, it is judged, according to the keyword, whether the cross-hierarchy filtering is adopted, and if the cross-hierarchy filtering is adopted, the process proceeds to step 4075; if the cross-hierarchy filtering is not adopted, the process proceeds to step 4080.

In step 4075, the cross-hierarchy filtering module is invoked, and the process proceeds to step 4080.

In step 4080, the recursion process control module is invoked, so as to start the subtree filtering, and the process proceeds to step 4090.

In step 4090, the filter results are processed correspondingly, and the process proceeds to step 4100.

In step 4100, an operation result encapsulation packet is returned to the relevant operation.

2. Naming Space Processing

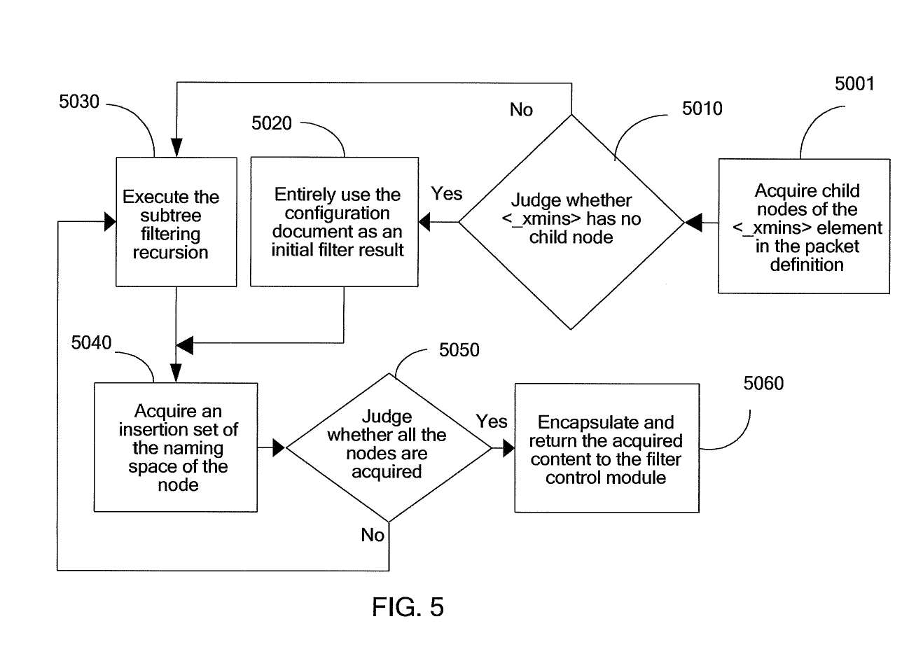

When the root node of the filter is <_xmlns>, the filter control invokes the naming space processing component, and announces that the packet is only the filter condition of the naming space. The returned result only includes the information of the naming space. FIG. 5 is a flow chart in which the filter control invokes the naming space processing component according to an embodiment of the present invention. As shown in FIG. 5, the process includes the following steps.

In step 5001, child nodes of the <_xmlns> element in the packet definition are acquired.

In step 5010, it is judged whether <_xmlns> has no child node, and if <_xmlns> has no child node, the process proceeds to step 5020; if the <_xmlns> has child node, the process proceeds to step 5030.

In step 5020, the configuration document is entirely used as an initial filter result, and the process proceeds to step 5040.

In step 5030, the subtree filtering recursion is performed.

In step 5040, an insertion set of the naming space of the node is acquired.

In step 5050, it is judged whether all the nodes are already acquired, and if all the nodes are already acquired, the process proceeds to step 5060; if not all the nodes are already acquired, the process proceeds to step 5030.

In step 5060, the acquired content is encapsulated and returned to the filter control module.

3. Recursion Process Control

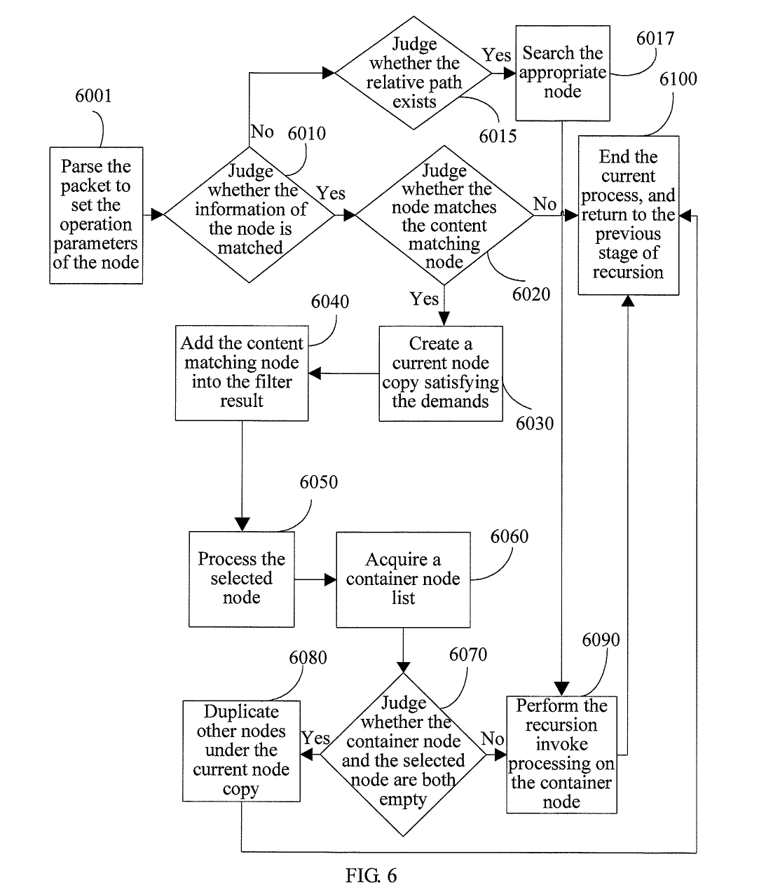

The recursion process control is basically similar to the realizing method in the protocol. FIG. 6 is a flow chart of recursion process control according to an embodiment of the present invention. Referring to FIG. 6, the process includes the following steps.

In step 6001, the packet is parsed to set the operation parameters of the node.

In step 6010, the node judges whether the information of the node itself is matched, and if the information of the node itself is matched, the process proceeds to step 6020; if the information of the node itself is not matched, the process proceeds to step 6015, where the information of the node itself includes a node type, a node name, a node attribute, and a node naming space, and the node attribute and the node naming space may have various logic relations.

In step 6015, the node judges whether the relative path exists, and if the relative path exists, the process proceeds to step 6017.

In step 6017, the appropriate node on the relative path is searched, and the process proceeds to step 6090.

In step 6020, the node judges whether the node itself matches the content matching node, and if the node itself matches the content matching node, the process proceeds to step 6030; if the node itself does not match the content matching node, the process proceeds to step 6100, where the content matching node includes the node having the text value and the node having the data scope and other conditions, and similarly, various logic relations may exist, and extended searching clauses may also exist.

In step 6030, a current node copy satisfying the demands is created, and the process proceeds to step 6040.

In step 6040, the content matching node is added into the filter result, and the process proceeds to step 6050.

In step 6050, the selected node is processed, where the selected node includes the nodes having no child node or having the child node as the built-in keyword, for example, <_count> in the filter. If the selected node is set to not show its descendent, only the node itself is duplicated; and if the selected node is set to not show its ancestor, the selected node is duplicated under the result root node, and the process proceeds to step 6060.

In step 6060, a container node list is acquired.

In step 6070, it is judged whether the container node and the selected node are empty, and if the container node and the selected node are empty, the process proceeds to step 6080; otherwise, the process proceeds to step 6090.

In step 6080, other nodes are duplicated under the current node copy, and the process proceeds to step 6100.

In step 6090, the recursion invoke processing is performed on the container node, and the process proceeds to step 6100.

In step 6100, the current process ends, and the previous stage of recursion is performed; the returned result includes the current node satisfying the filter condition and the descendents thereof, and may also include a part of nodes not satisfying the filter condition while being remained due to the reservation of other nodes, but not includes meaningless nodes for the user.

4. Node Function Processing

The node function processing module accepts the invocation of the recursion process control, and realizes the processing function for a single node. The node function processing module starts from a certain node in the filter definition, reserves the node satisfying the filter condition represented by the node in the configuration document, and performs some processing on the reserved node in the configuration document according to the stated demands.

The functions of the node function processing module include: matching the node, selecting the text content as the node having a specific numerical value, selecting the text content as the node having a specific time, searching the number of the child nodes, carrying out the AND, OR, and NOT logic operations of the attribute and the naming space, and finding the node of the configuration document that is similar to the current node but has an incomplete path.

The node function processing module accepts the parameters transferred by the recursion control part, performs the corresponding process, and returns the processed result to the recursion control module.

The main realizing method is as follows.

(1) Fuzzy Matching

It is judged whether the attributes of two nodes in the configuration document and the filter document conform to fuzzy matching. Firstly, the contents of the text nodes are appropriately pre-processed, and then it is judged whether the two nodes are matched according to a regular expression.

(2) The Node Having the Text Content Being the Specific Numerical Value Scope is Selected.

Firstly, it is judged whether the text content may be converted to the numerical value type, and if the text content may be converted to the numerical value type, it continues to judge whether the numerical value is within the designated numerical value scope, where the judgment of the numerical value scope includes four parts : greater than, smaller than, not greater than, and not smaller than the designated numerical value.

(3) The Node Having the Text Content Being the Specific Time Scope is Selected.

Firstly, it is judged whether the text content may be converted to the data representing the time, and if the text content may be converted to the data representing the time, it continues to judge whether the data is within the designated time scope, where the judgment of the time scope includes: earlier than, later than, not earlier than, and not later than the designated time.

(4) The Searching of the Number of the Child Nodes

A node counter is set, when the matched node is found, 1 is added to the counter; and when the node is incorporated to the document of the filter result, only the node itself and the number of nodes are duplicated.

(5) The Configuration Document Node Similar to the Current Node but Having an Incomplete Path is Found.

The node is found in the current node descendants according to a part of characteristics of the node, and matches with the current node, for being used by the relative path function module.

(6) Logic Relation Between the Attribute and the Naming Space

Firstly, it is determined whether the configuration document node satisfies each naming space and attribute given in the filter, and the determination result is indicated by “true” or “false”. Then, a value of a Boolean expression is calculated.

5. The Result Processing Module Realizes the Following Functions.

Packet encapsulation: The filter results are encapsulated into an appropriate packet format according to the parameters set in the filter control, and are returned to the filter control.

Node combination: The filter results having the same structure are combined.

Node sorting: The filter results are sorted according to the value of the given node, and the sorted results are returned. FIG. 7 is a flow chart of realizing result processing according to an embodiment of the present invention. Referring to FIG. 7, a basic result processing flow includes the following steps.

In step 7010, it is judged whether the filter is empty, and if the filter is empty, the process proceeds to step 7020.

In step 7020, the entire configuration document is copied.

In step 7030, it is judged whether the searching of the naming space is performed, and if the searching of the naming space is performed, the process proceeds to step 7040.

In step 7040, the naming space and the prefix are retrieved.

In step 7050, the node sorting or the node combination is performed.

In step 7060, the packet is encapsulated and returned.

### Embodiment 1

It is assumed that a data model managed by a device end is as shown in Example 37.

### EXAMPLE 37

### The Data Model Managed by the Device End

```
        <netconf xmlns=“urn:ietf:params:xml:ns:netconf:base:1.0”
    xmlns:mt=“urn:bupt:pris:priser:agent:module:monitor:1.0”
    xmlns:if=“urn:bupt:pris:priser:agent:module:interface:1.0”>
          <routing>
            <if:interface name=“Ethternet1” ip=“59.64.139.65”>
              <if:name>Ethernet1</if:name>
              <if:mac-address>0006GG93KAG8</if:mac-address>
              <if:ipv4>
                <if:address-v4>59.64.139.65</if:address-v4>
                <if:flags up=“true”/>
                < if:received>19< /if:received>
              </if:ipv4>
            </if:interface>
            <if:interface name=“Ethternet2” ip=“59.64.139.69”>
              <if:name>Ethernet2</if:name>
              <if:mac-address>000E35A83K4K</if:mac-address>
              <if:ipv4>
                <if:address-v4>59.64.139.69</if:address-v4>
                <if:flags up=“false”/>
                < if:received>49< /if:received>
              </if:ipv4>
            </if:interface>
          </routing>
          <mt:monitor>
            <mt:configuration>running-state</mt:configuration>
            <mt:configuration>startup-config</mt:configuration>
            <mt:configuration>running-config</mt:configuration>
<if:configuration>http://pris.bupt.cn/example/</if:configuration>
          </mt:monitor>
        </netconf>
```

The data model is searched, and the filter is defined as follows.

### EXAMPLE 38

### Definition of the Filter of the Embodiment

```
        <filter type=“advancedSubtree” _nodepath=“relative”>
          <if:interface name=“Ethternet1”
ip=“59.64.139.65”_attrLogic=“(name \hat{ }ip) || (!name \hat{ }!ip)”
                xmlns:if=“*interface*”/>
            <_count = true/>
          </if:interface>
          <mt:monitor xmlns:mt=“*monitor:1.0”>
            <configuration _nsLogic=“if || mt” _order=“asc”/>
          </mt:monitor>
        </filter>
```

When the get/get-config operation finds that the operation packet includes the filter node, the filter node is delivered to the filter control module in FIG. 2. The module invokes the parameter setting module in FIG. 2, learns from the attribute type=“advancedSubtree” of the filter that a subtree filtering extending function operation needs to be performed, parses that the matching of the relative path is required, and sends the parameter _nodepath to the process control to start extending the subtree filtering operation, as shown by step 4020 in FIG. 4.

The main process of defining the filter is as follows.

Before the operation starts, the packet is checked and no syntax error is found.

The <_xmlns> element is not found, and it is considered as the non-naming space searching.

The first child node interface of the filter matches with the root node netconf of the data model. Since the names are different, the matching fails.

Due to the non-absolute path, the nodes, being <if:interface name=“Ethternet1” ip=“59.64.139.65”\> and <if:interface name=“Ethternet2” ip=“59.64.139.69”\>, matching with the interface are found from the descendants of the netconf node.

The filter condition of the combination of the logic relations of the attributes is used in finding the matched nodes. name=“Ethternet1” ip=“59.64.139.65”_attrLogic=” (namêip)∥(!namê!ip)” represents that for the interface node in the filter result, both name and ip satisfy given conditions, or neither of the two satisfies the given conditions. During matching, for the node in the data model <if:interface name=“Ethternet1” ip=“59.64.139.65”>, the name attribute condition is satisfied, and the ip attribute condition is also satisfied. The matching result of the expression introduced by the _attrLogic is: (truêtrue)∥(falsêfalse)=true, that is, the node in the data model satisfies the logic relation filter condition of the attribute. Similarly, another interface under routing satisfies the condition as well.

The fuzzy matching of the naming space is used in finding the matched nodes. The “urn:bupt:pris:priser:agent:module:interface:1.0” includes the character string “interface”, and may be matched.

The <if:interface name=“Ethternet1” ip=“59.64.139.65”> node matches the interface node in the filter, and the child nodes of the node are processed, where the child nodes are sibling nodes and are processed at the same time.

The interface node of the filter only has the <_> node, and has no attribute limit condition, thereby matching any element type node having the naming space including the character string “interface”. Therefore, name, mac-address, and ipv4 nodes all satisfy the filter condition.

The <_> node has a _count attribute value being “true”, and the number of the nodes in the data model matching the <_> node is counted to be 3. Therefore, the function of counting the number of the interface child nodes is realized.

The subtree of the filter is as follows:

```
        <if:interface name=“Ethternet1”
ip=“59.64.139.65”_attrLogic=“(name \hat{ } ip) || (!name \hat{ } !ip)”
xmlns:if=“*interface*”/>
            <_count = true/>
          </if:interface>
```

The acquired filter result is as follows:

```
<if:interface name=“Ethternet1” ip=“59.64.139.65”>
  <_countNum>3<_countNum>
</if:interface>
<if:interface name=“Ethternet2” ip=“59.64.139.69”>
  <_countNum>3<_countNum>
</if:interface>
```

The matched node and the ancestors are duplicated to the filter result.

The sibling nodes monitor of interface in the filter are processed.

The naming space “urn:bupt:pris:priser:agent:module:interface:1.0” of monitor in the data model includes a character string “monitor:1.0” at the end. With no other matching conditions, the mt:monitor node is matched.

The child node configuration of the monitor node of the filter is processed. The naming spaces of the configuration element in the data model have two types, that is, urn:bupt:pris:priser:agent:module:monitor:1.0 and urn:bupt:pris:priser:agent:module:interface:1.0, and match *monitor:1.0 represented by mtr, or satisfy *interface* represented by if. In the data model, four configuration nodes having the same parent node are matched.

The subtree of the filter is as follows:

<mt:monitor xmlns:mt=“*monitor:1.0”>
<configuration _nsLogic=“if || mt” _order=“asc”/>
</mt:monitor>

The acquired filter result is as follows:

```
        <mt:monitor>
          <mt:configuration>running-state</mt:configuration>
          <mt:configuration>startup-config</mt:configuration>
          <mt:configuration>running-config</mt:configuration>
<if:configuration>http://pris.bupt.cn/example/</if:configuration>
        </mt:monitor>
```

The matched node and the ancestor are duplicated to the filter result.

The nodes in the filter are already matched, so as to acquire the initial filter result as follows:

```
      <netconf xmlns=“urn:ietf:params:xml:ns:netconf:base:1.0”
  xmlns:mt=“urn:bupt:pris:priser:agent:module:monitor:1.0”
  xmlns:if=“urn:bupt:pris:priser:agent:module:interface:1.0”>
        <routing>
          <if:interface name=“Ethternet1” ip=“59.64.139.65”>
            <_countNum>3<_countNum>
          </if:interface>
          <if:interface name=“Ethternet2” ip=“59.64.139.69”>
            <_countNum>3<_countNum>
          </if:interface>
        </routing>
        <mt:monitor>
          <mt:configuration>running-state</mt:configuration>
          <mt:configuration>startup-config</mt:configuration>
          <mt:configuration>running-config</mt:configuration>
<if:configuration>http://pris.bupt.cn/example/</if:configuration>
        </mt:monitor>
      </netconf>
```

The filter results acquired by the configuration node in the filter are sorted. The text content is not empty, and the results are sorted in the ascending order. The monitor subtree is changed to:

```
        <mt:monitor>
          <if:configuration>http://pris.bupt.cn/example/</
if:configuration>
          <mt:configuration>running-config</mt:configuration>
          <mt:configuration>running-state</mt:configuration>
          <mt:configuration>startup-config</mt:configuration>
        </mt:monitor>
```

The sorted filter results are delivered to the control module, so as to be returned to the upper stage for being operated.

The finally acquired filter result is as shown in Example 39.

### EXAMPLE 39

### The Filter Result of Example 38

```
      <netconf xmlns=“urn:ietf:params:xml:ns:netconf:base:1.0”
  xmlns:mt=“urn:bupt:pris:priser:agent:module:monitor:1.0”
  xmlns:if=“urn:bupt:pris:priser:agent:module:interface:1.0”>
        <routing>
          <if:interface name=“Ethternet1” ip=“59.64.139.65”>
            <_countNum>3<_countNum>
          </if:interface>
          <if:interface name=“Ethternet2” ip=“59.64.139.69”>
            <_countNum>3<_countNum>
          </if:interface>
        </routing>
        <mt:monitor>
<if:configuration>http://pris.bupt.cn/example/</if:configuration>
          <mt:configuration>running-config</mt:configuration>
          <mt:configuration>running-state</mt:configuration>
          <mt:configuration>startup-config</mt:configuration>
        </mt:monitor>
      </netconf>
```

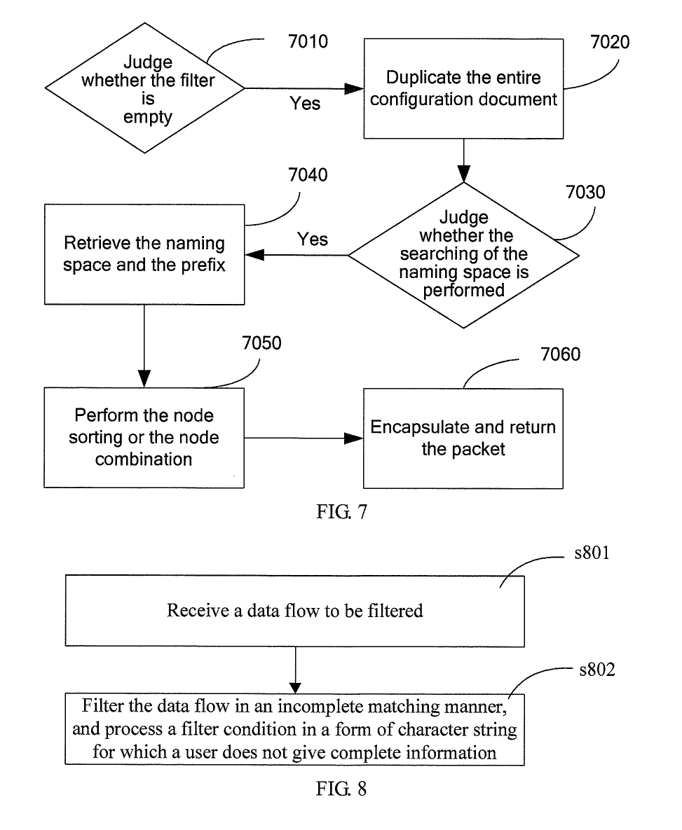

FIG. 8 is a flow chart of a fuzzy searching method based on subtree filtering according to Embodiment 2 of the present invention. Referring to FIG. 8, the method includes the following steps.

In step s801, a data flow to be filtered is received.

In step s802, the data flow is filtered in an incomplete matching manner, and a filter condition in a form of character string for which a user does not give complete information is processed.

The character string includes a node name, a node content, an attribute name, an attribute value, and a naming space; and the incomplete matching manner includes that a path is incomplete; an element name is incomplete, an element value is incomplete, an attribute name is incomplete, an attribute value is incomplete, and a naming space is incomplete.

When the data flow is filtered in the incomplete matching manner, specifically, the data flow is filtered through an absolute path; or the data flow is filtered through a relative path.

When the data flow is filtered through the absolute path, specifically, a filter provided by the user includes all ancestors of a selected node from a root node, and filter results only include nodes and node descendants having completely the same ancestor in the filter and in a data model.

When the data flow is filtered through the relative path, specifically, a node satisfying a parent-child relation in a filter at least satisfies an ancestor-descendant relation; and a node being a root node in the filter at least includes a non-root node in the filter results.

When a naming space of a node is not matching, it continues to process a child node of the node, and reserve an element with the not matching naming space as a path of a descendant node.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

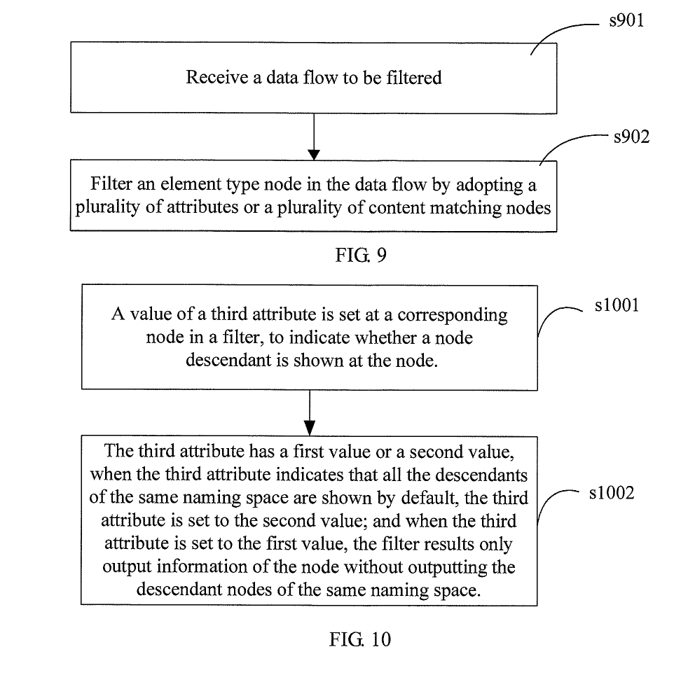

FIG. 9 is a flow chart of a subtree filter condition logic combination extending method according to Embodiment 3 of the present invention. Referring to FIG. 9, the method includes the following steps.

In step s901, a data flow to be filtered is received.

In step s902, an element type node in the data flow is filtered by adopting a plurality of attributes or a plurality of content matching nodes.

In step s902, when the element type node in the data flow is filtered by adopting the plurality of content matching nodes, specifically, the content matching nodes are used as filter conditions for selecting a specific parent node from a data model; matching degrees of the content matching nodes are represented by adding a first attribute into the content matching nodes, where the matching degrees include mandatory matching, optional matching, and not matching; and the element type node in the data flow is filtered according to the content matching nodes and the matching degrees.

When the element type node in the data flow is filtered according to the content matching nodes and the matching degrees, specifically, when all the content matching nodes having the matching degree being the mandatory matching in a filter completely match the corresponding element type nodes in the data model, the parent node is added into filter results; when at least one of the content matching nodes having the matching degree being the optional matching in the filter completely matches the corresponding element type nodes in the data model, the parent node is added into the filter results; and when the content matching nodes having the matching degree being not matching in the filter completely match the corresponding element type nodes in the data model, the parent node is not added into the filter results.

In addition, a second attribute is added into the node, so as to show a logic relation among a plurality of attributes of the node, where the second attribute is an _attrLogic attribute.

When the element type node in the data flow is filtered by adopting the plurality of content matching nodes, a naming space is searched, and specifically, a definition situation of the naming space in a data model is acquired, and a naming space list is given, where a keyword for searching the naming space is represented by one element.

When the element type node in the data flow is filtered by adopting the plurality of content matching nodes, the filter condition further includes a scope condition, the scope condition is used to select a node having certain specific numerical values or date scopes, an attribute representing an attribute scope or a time scope is added into the selected node representing number or time, the selected node is regarded as the content matching node representing the time or the number scope, and the selected node is used as the filter condition in filter processing.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

FIG. 10 is a flow chart of a subtree filtering searching result processing method according to Embodiment 4 of the present invention. Referring to FIG. 10, the method includes the following steps.

In step s1001, a value of a third attribute is set at a corresponding node in a filter, to indicate whether a node descendant is shown at the node, where the third attribute is a show attribute.

In step s1002, the third attribute has a first value or a second value, when the third attribute indicates that all descendants of the same naming space are shown by default, the third attribute is set to the second value; and when the third attribute is set to the first value, filter results only output information of the node without outputting the descendant nodes of the same naming space.

The processing method further includes: counting the number of a certain type of elements in a data model by realizing number searching by using a fourth attribute in a certain element type node in the filter, and counting the number of elements corresponding to the same filter node by realizing number searching by using a fourth attribute in a certain element type node in the filter. The fourth attribute is a count attribute.

The fourth attribute has two values being a first value and a second value, the first value is “true”, and the second value is “false”, when the fourth attribute value is set to be the first value, the filter results output the number of searching entities; and when the fourth attribute is set to be the second value, the filter results do not output the number of the searching entities.

The processing method further includes: sorting the filter results acquired by the same filter node according to demands, and combining the nodes having completely the same content in a searching result.

The processing method further includes: when all the nodes to be matched are discarded for having no matching node in the data model, not returning a parent node of the nodes.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

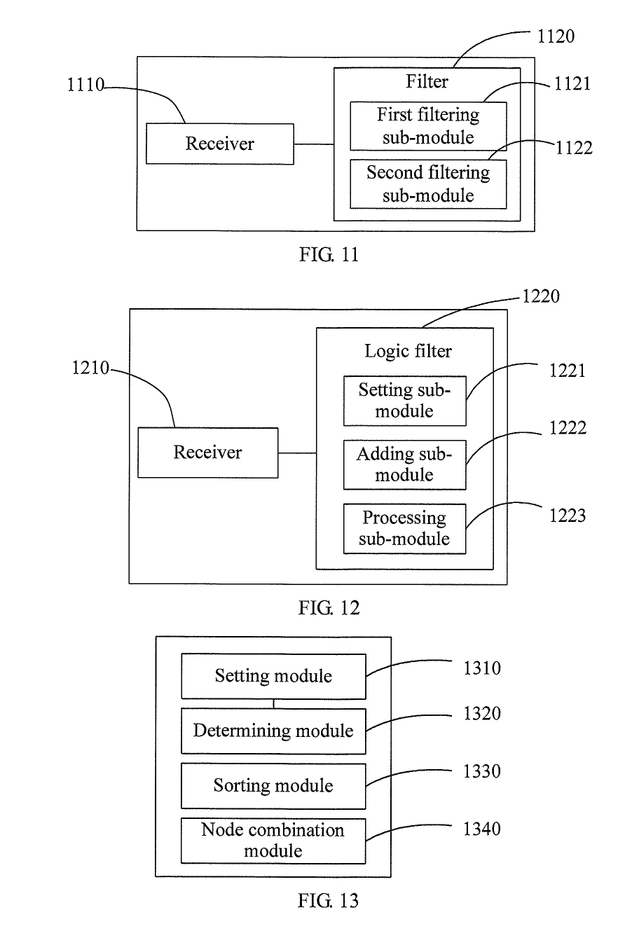

FIG. 11 is a schematic structural view of a filter according to Embodiment 5 of the present invention. Referring to FIG. 11, the filter includes a receiver 1110 and a filtering module 1120.

The receiver 1110 is configured to receive a data flow to be filtered.

The filtering module 1120 is configured to filter the data flow in an incomplete matching manner, and process a filter condition in a form of character string for which a user does not give complete information.

The filtering module 1120 includes a first filtering sub-module 1121 and/or a second filtering sub-module 1122.

The first filtering sub-module 1121 is configured to filter the data flow through an absolute path.

The second filtering sub-module 1122 is configured to filter the data flow through a relative path.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

FIG. 12 is a schematic structural view of a logic filter according to Embodiment 6 of the present invention. Referring to FIG. 12, the logic filter includes a receiver 1210 and a logic filtering module 1220.

The receiver 1210 is configured to receive a data flow to be filtered.

The logic filtering module 1220 is configured to filter an element type node in the data flow by adopting a plurality of attributes or a plurality of content matching nodes.

The logic filtering module 1220 includes a setting sub-module 1221, an adding sub-module 1222, and a processing sub-module 1223.

The setting sub-module 1221 is configured to set the content matching nodes as filter conditions for selecting a specific parent node from a data model.

The adding sub-module 1222 is configured to represent matching degrees of the content matching nodes by adding a first attribute into the content matching nodes, and realize a logic relation combination among the filter conditions of the content matching nodes.

The processing sub-module 1223 is configured to filter the element type node in the data flow according to the logic relation combination among the filter conditions.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

FIG. 13 is a schematic structural view of a subtree filtering searching result processing apparatus according to Embodiment 7 of the present invention. Referring to FIG. 13, the apparatus includes a setting module 1310 and a determining module 1320.

The setting module 1310 is configured to set a value of a third attribute at a corresponding node in a filter, where the third attribute is a _show attribute.

The determining module 1320 is configured to indicate whether a node descendant is shown at the node according to the value of the third attribute set by the setting module 1310.

The processing apparatus further includes a sorting module 1330 and a node combination module 1340.

The sorting module 1330 is configured to sort filter results acquired by the same filter node according to demands.

The node combination module 1340 is configured to combine the nodes having completely the same content in a searching result.

To sum up, it maybe known that the present invention may realize the following functions which cannot be realized, or have a bad realizing effect, or have a defective processing method in the subtree filtering mechanism in the NETCONF protocol, as shown in Table 2.

TABLE 2
Additive functions realized by extended subtree filtering mechanism

| Function | | |
|---|---|---|
| Category | Realized by Extended Function | Remarks |
| Fuzzy | Fuzzy matching of node name, node value, | |
| searching | attribute name, attribute value, and | |
| filtering | naming space | |
| | Mutual searching between attribute name | Realized through matching |
| | and value | all the non-empty characters |
| | Mutual searching between node name and | Realized through matching |
| | value | all the non-empty characters |
| | Searching of the relative path or the | Capable of realizing the |
| | unknown path | function of searching node or |
| | | attribute in the entire |
| | | document |
| Logic | OR, AND logic relation of the filtering | |
| relation of | of the naming space | |
| filter | OR, AND, NOT logic relation of the filter | |
| condition | condition of the attribute | |
| | OR, AND, NOT logic relation of the content | |
| | matching node | |
| Naming | All the naming spaces in the document | |
| space | are searched. | |
| | All the naming spaces in the subtree are | |
| | searched. | |
| | All the elements in a certain naming space | The processing of the |
| | are searched. | matching of the naming space |
| | | is different from that of the |
| | | former protocol |
| | The naming spaces corresponding to the | Realized through the fuzzy |
| | prefix are searched. | filtering |
| | The matching of the naming space is | |
| | invalid during filtering. | |
| Removal of | Only the selected node is output. | |
| redundant | When the searching target is not | |
| information | matching, the ancestor is also | |
| | discarded. | |
| | The same subtrees are combined. | |
| Searching | Searching of the number of the entities | |
| clause | Number and time scope condition | |
| extension | Sorting of the subtrees of the same | |
| | structure | |

It can be know from Table 2 that:

In the embodiments of the present invention, a method for searching and filtering XML network management data, expressed in an XML form, and based on a NETCONF subtree filtering mechanism, is provided, to more conveniently acquire management information in the NETCONF protocol, and prevent problems resulting from redefining a set of rules for data searching and filtering.

In the embodiments of the present invention, a mechanism for refining and combining XML data filter conditions is provided. In the present invention, a matching degree of a node is refined, and a user may select a corresponding searching method according to specific functions of the node in data storage. In addition, filter conditions expressed in the attribute and naming space manners may be combined together in a logic operation manner, so that the searching becomes more flexible.

In the embodiments of the present invention, when a filter condition is incomplete, for example, a node or an attribute name in data storage cannot be completely spelled, or a defined position of data in an XML document cannot be completely given, a subtree filtering operation may still be performed on XML data, and a result required by a user is acquired.

In the embodiments of the present invention, a searching function of a naming space in subtree filtering is added, so as to help a user to quickly know a structure of data distribution in an XML document; and compensate a defect that a naming space condition needs to be given in NETCONF protocol subtree filtering, but a complete means is not provided for realizing naming space searching.

In the embodiments of the present invention, special searching demands for certain data are processed, for example, time, date, number, and other scope searching, and data number searching, so that subtree filtering may further satisfy demands in actual network management or other actual applications.

In the embodiments of the present invention, filter results are optimized, so as to combine or sort the same or similar data; and if necessary, useless descendant nodes are discarded, thereby reducing a great amount of redundant information possibly existing in the subtree filter result.

Through the above description in the detailed description, it is clear to persons skilled in the art that the present invention may be accomplished through hardware, or through software plus necessary universal hardware platform. Base on this, the technical solutions of the present invention may be embodied in the form of a software product. The software product may be stored in one or more nonvolatile storage media (for example, CD-ROM, USB flash drive, or removable hard disk) and contain several instructions configured to instruct a computer equipment (for example, a personal computer, a server, or a network equipment) to perform the method according to the embodiments of the present invention.

The above descriptions are merely some exemplary embodiments of the present invention. It should be noted by persons of ordinary skill in the art that modifications and improvements maybe made without departing from the principle of the present invention, which should be construed as falling within the scope of the present invention.

What is claimed is:

1. A method for fuzzy searching based on subtree filtering, the method comprising:
receiving a data flow to be filtered; and
filtering the data flow in an incomplete matching manner, and processing a filter condition in a form of character string for which a user does not give complete information.

2. The method according to claim 1, wherein the character string comprises a node name, a node content, an attribute name, an attribute value, or a naming space.

3. The method according to claim 1, wherein the incomplete matching manner comprises that a path is incomplete, an element name is incomplete, an element value is incomplete, an attribute name is incomplete, an attribute value is incomplete, and a naming space is incomplete.

4. The method according to claim 1, wherein the filtering the data flow in the incomplete matching manner comprises:
filtering the data flow through an absolute path; or
filtering the data flow through a relative path.

5. The method according to claim 4, wherein in the filtering the data flow through the absolute path,
a filter provided by the user comprises all ancestors of a selected node from a root node, and filter results only comprise nodes and node descendants having completely the same ancestor in the filter and in a data model.

6. The method according to claim 4, wherein in the filtering the data flow through the relative path,
a node satisfying a parent-child relation in a filter at least satisfies an ancestor-descendant relation; and a node being a root node in the filter at least comprises a non-root node in filter results.

7. The method according to claim 4, further comprising:
when a naming space of a node is not matching, continuing to process a child node of the node, and reserving an element with the not matching naming space as a path of a descendant node.

8. A method for extending a logic combination of subtree filter condition, the method comprising:
receiving a data flow to be filtered; and
filtering an element type node in the data flow by adopting a plurality of attributes or a plurality of content matching nodes.

9. The method according to claim 8, wherein the filtering the element type node in the data flow by adopting the plurality of content matching nodes comprises:
using the content matching nodes as filter conditions for selecting a specific parent node from a data model;
representing matching degrees of the content matching nodes by adding a first attribute into the content matching nodes, wherein the matching degrees comprise mandatory matching, optional matching, and not matching; and
filtering the element type node in the data flow according to the content matching nodes and the matching degrees.

10. The method according to claim 9, wherein the filtering the element type node in the data flow according to the content matching nodes and the matching degrees comprises:
when all the content matching nodes having the matching degree being the mandatory matching in a filter completely match the corresponding element type nodes in the data model, adding the parent node into filter results;
when at least one of the content matching nodes having the matching degree being the optional matching in the filter completely matches the corresponding element type nodes in the data model, adding the parent node into the filter results; and
when the content matching nodes having the matching degree being the not matching in the filter completely match the corresponding element type nodes in the data model, not adding the parent node into the filter results.

11. The method according to claim 8, further comprising:
adding a second attribute into the node, so as to show a logic relation among a plurality of attributes of the node.

12. The method according to claim 8, further comprising searching a naming space:
acquiring a definition situation of the naming space in a data model, and giving a naming space list, wherein a keyword for searching the naming space is represented by one element.

13. The method according to claim 9, wherein the filter condition further comprises a scope condition, the scope condition is configured to select a node having certain specific numerical values or date scopes, an attribute representing an attribute scope or a time scope is added into the selected node representing number or time, regarding the selected node as the content matching node representing the time or the number scope, and using the selected node as the filter condition in a filtering process.

14. A method for processing a subtree filtering searching result, the method comprising:
setting a value of a third attribute at a corresponding node in a filter, so as to indicate whether a node descendant is shown at the node,
wherein the third attribute has a first value or a second value, when the third attribute indicates that all descendants of the same naming space are shown by default, the third attribute is set to the second value; and when the third attribute is set to the first value, filter results only output information of the node without outputting the descendant nodes of the same naming space.

15. The method according to claim 14, further comprising:
counting the number of a certain type of elements in a data model by realizing number searching by using a fourth attribute in a certain element type node in the filter.

16. The method according to claim 14, further comprising:
counting the number of elements corresponding to the same filter node by realizing number searching by using a fourth attribute in a certain element type node in the filter.

17. The method according to claim 15, wherein
the fourth attribute has two values being a first value and a second value, when the fourth attribute value is set to be the first value, the filter results output the number of searching entities; and when the fourth attribute is set to be the second value, the filter results do not output the number of the searching entities.

18. The method according to claim 14, further comprising:
sorting the filter results acquired by the same filter node according to demands, and combining the nodes having completely the same content in a searching result.

19. The method according to claim 14, further comprising:
when all the nodes to be matched are discarded for having no matching node in the data model, not returning a parent node of the nodes.

20. A filter comprising:
a receiver, configured to receive a data flow to be filtered; and
a filtering module, configured to filter the data flow in an incomplete matching manner, and process a filter condition in a form of character string for which a user does not give complete information.

21. The filter according to claim 20, wherein the filtering module comprises:
a first filtering sub-module, configured to filter the data flow through an absolute path; or a second filtering sub-module, configured to filter the to flow through a relative path.

22. A logic filtering apparatus, the apparatus comprising:
a receiver, configured to receive a data flow to be filtered; and
a logic filtering module, configured to filter an element type node in the data flow by adopting a plurality of attributes or a plurality of content matching nodes.

23. The apparatus according to claim 22, wherein the logic filtering module comprises:
a setting sub-module, configured to set the content matching nodes as filter conditions for selecting a specific parent node from a data model;
an adding sub-module, configured to represent matching degrees of the content matching nodes by adding a first attribute into the content matching nodes, and realize a logic relation combination among the filter conditions of the content matching nodes; and
a processing sub-module, configured to filter the element type node in the data flow according to the logic relation combination among the filter conditions.

24. An apparatus for processing a subtree filtering searching result, the apparatus comprising:
a setting module, configured to set a value of a third attribute at a corresponding node in a filter; and
a determining module, configured to indicate whether a node descendant is shown at the node according to the value of the third attribute set by the setting module.

25. The apparatus according to claim 24, further comprising:
a sorting module, configured to sort filter results acquired by the same filter node according to demands; and
anode combination module, configured to combine the nodes having completely the same content in a searching result.
